(19) United States
(12) Patent Application Publication
(10) Pub. No.: US 2026/0323769 A1
(43) Pub. Date: Oct. 15, 2026

(54) METHOD FOR INTEGRATED ACCESS AND BACKHAUL (IAB) NODE DEAUTHORIZATION HANDLING

(71) Applicant: Telefonaktiebolaget LM Ericsson (publ), Stockholm (SE)

(72) Inventors: Filip BARAC, HUDDINGE (SE); Qian CHEN, MÖLNDAL (SE); Paul SCHLIWA-BERTLIN, LJUNGSBRO (SE)

(73) Assignee: Telefonaktiebolaget LM Ericsson (publ), Stockholm (SE)

(21) Appl. No.: 19/485,243

(22) PCT Filed: May 17, 2024
(86) PCT No.: PCT/IB2024/054829

§ 371 Date: Nov. 17, 2025

Related U.S. Application Data
(60) Provisional application No. 63/467,276, filed on May 17, 2023.

(51) Int. Cl. H04W 76/30; H04W 12/082; H04W 84/04; H04W 88/08

(52) U.S. Cl. CPC H04W 76/30; H04W 12/082; H04W 84/047; H04W 88/085

(57) ABSTRACT

A method performed by a network node for conducting de-authorization of an integrated access and backhaul (IAB) node is disclosed. In one example, the method includes receiving, by a F1 terminating donor from a non-F1 terminating donor, an IAB transport migration modification request indicating that the IAB node and/or its associated IAB-MT has been de-authorized to operate in a network; sending, to the non-F1 terminating donor, an IAB transport migration modification response acknowledging the receipt of the IAB transport migration modification request; and sending, by the F1 terminating donor to an IAB-DU associated with the IAB node, a request for releasing an F1 connection established between the IAB-DU and the F1 terminating donor.

### TECHNICAL FIELD

The present disclosure relates generally to communications, and more particularly to methods and related mobile devices and mobile network nodes performing wireless and/or cellular based communications and signaling.

### BACKGROUND

3GPP Release-18 is pursuing a work item related to vehicle mounted radio base station, i.e., a mobile base station relay. The baseline for the work includes Integrated Access and Backhaul (IAB) architecture that is developed in 3GPP Release-16/17 where the IAB-node is stationary.

Release-16/17 specifies that an IAB-node comprises the IAB user equipment (IAB-UE), also referred to as the IAB mobile termination (IAB-MT) function in Radio Access Network (RAN) Working Groups specifications, and the IAB distributed unit (IAB-DU) part. The IAB-UE part registers itself to the 5GS system as a “UE” (“user equipment”) via the gNodeB (gNB) that is capable of performing a donor function to manage the IAB-node. After the registration, the IAB-DU part can be configured to act as a DU with management from the donor-gNB (e.g., donor-gNB provides backhaul/F1-C related information to IAB-UE via radio resource control (RRC) messages, then backhaul and F1-C can be set up between IAB-DU and donor-gNB). The UEs may then access the 5GS via the cell broadcasted by IAB-DU.

In Release-16, the LAB-UE and the IAB-DU shall connect to the same donor. From Release-17, the IAB-UE and IAB-DU can be managed by different donor-gNBs.

Release-17 specifies that an IAB-UE can be handed over to a different donor-gNB than the donor serving its so-located IAB-DU. After the IAB-MT handover, the IAB-MT and IAB-DU are served by different donors. The IAB-MT can then stay connected to another donor permanently, or it can be handed over back to the IAB-DU's donor.

In Release-18, the mobile IAB-DU (mIAB-DU) and mobile IAB-MT (mIAB-MT) can both be handed over to different donors, as the mIAB-node moves.

### SUMMARY

There currently exist certain challenge(s). When an IAB-node needs to be taken out from the system (e.g., because subscription data for the IAB-node is updated and a previously authorized IAB-node is no longer authorized to operate as an IAB-node in the network), the core network (CN) first informs the donor that the IAB-node is not authorized anymore via Next Generation Application Protocol (NGAP) signaling. Afterwards, the donor takes actions so that the IAB node does not serve any UEs anymore. Examples of these actions taken by the donor include: 1) Handing over the UEs served by cells configured on the IAB-node to other cells served by other IAB nodes or other radio access network (RAN) nodes, 2) Triggering the release of F1 connection between IAB-DU and the donor central unit (CU), and 3) Removal of the backhaul resources and Backhaul Adaptation Protocol (BAP) routing configuration at the ancestor nodes of the de-authorized IAB-node.

As explained above, since Release-17, there are scenarios where the donor serving the IAB-MT and the donor serving the IAB-DU are different, and the same holds true for Release-18 mobile IAB-nodes. In this case (e.g., two donors), when the IAB-node is not authorized, it is the donor of the IAB-MT that receives the “non-authorized” indication from the CN via NGAP signaling. However, to perform actions 1 and 2 above (e.g., handing over UEs to other RAN nodes and F1 connection release, respectively), the donor serving the IAB-DU needs to be informed by the donor serving the IAB-MT that the IAB-MT is no longer authorized (e.g., in this case, action 3 is applicable for the IAB-MT's donor). Only after the actions 1 and 2 are completed can the action 3 be taken. At present, it is unclear how to inform the donor serving the IAB-DU that the IAB-MT is no longer authorized, so that the IAB-DU's donor can release the F1 connection with the IAB-DU.

Certain aspects of the disclosure and their embodiments may provide solutions to these or other challenges. The disclosed subject matter provides a solution for notifying the donor CU serving the IAB-DU/mIAB-DU that the IAB-MT/mIAB-MT is not authorized for operating in the RAN, so that the donor CU serving the IAB-DU/mIAB-DU can hand over the UEs served by the IAB-node to other RAN nodes, and remove the F1 connection (both user plane and control plane) to the mIAB-DU and release the resources for the F1 connection.

In one embodiment, a method performed by a network node for conducting de-authorization of an IAB node according to a first solution is disclosed. The method includes receiving, by a F1 terminating donor from a non-F1 terminating donor, an IAB transport migration modification request indicating that the IAB node and/or its associated IAB-MT has been de-authorized to operate in a network; sending, to the non-F1 terminating donor, an IAB transport migration modification response acknowledging the receipt of the IAB transport migration modification request; and sending, by the F1 terminating donor to an IAB-DU associated with the IAB node, a request for releasing an F1 connection established between the IAB-DU and the F1 terminating donor. In some embodiments, the operations of the disclosed method may be executed by a network node and/or a control system. More specifically, the method may include a software program and/or algorithm that is stored in the memory of a network node (and/or control system) and when executed by the processing circuitry may perform the operations indicated by the recited steps. In some embodiments, the method may be embodied in a non-transitory computer readable medium that stores instructions executable by processing circuitry of a network node and/or a control system, wherein the instructions executed by the processing circuitry perform operations including the steps of the disclosed method of the first solution.

In one embodiment, a method performed by a network node for conducting de-authorization of an IAB node according to a second solution is disclosed. The method includes receiving, by a F1 terminating donor from a non-F1 terminating donor, an IAB transport migration modification request indicating that the IAB node and/or its associated IAB-MT has been de-authorized to operate in a network; sending, by the F1 terminating donor to an IAB-DU associated with the IAB node, a request for releasing an F1 connection established between the IAB-DU and the F1 terminating donor; and sending, to the non-F1 terminating donor, an IAB transport migration modification response requesting a release of resources used by the non-F1 terminating donor to facilitate the packet traffic communicated to and from the IAB node. In some embodiments, the operations of the disclosed method may be executed by a network node and/or a control system. More specifically, the method may include a software program and/or algorithm that is stored in the memory of a network node (and/or control system) and when executed by the processing circuitry may perform the operations indicated by the recited steps. In some embodiments, the method may be embodied in a non-transitory computer readable medium that stores instructions executable by processing circuitry of a network node and/or a control system, wherein the instructions executed by the processing circuitry perform operations including the steps of the disclosed method of the second solution.

In one embodiment, a method performed by a network node for conducting de-authorization of an IAB node according to a third solution is disclosed. The method includes receiving, by a F1 terminating donor from a non-F1 terminating donor, an IAB transport migration modification request indicating that the IAB node and/or its associated IAB-MT has been de-authorized to operate in a network; sending, by the F1 terminating donor to an IAB-DU (860) associated with the IAB node, a request for releasing an F1 connection established between the IAB-DU and the F1 terminating donor; and sending, by the IAB-DU to the IAB-MT, a first notification message indicating the F1 connection has been removed via node-internal signaling. In some embodiments, the operations of the disclosed method may be executed by a network node and/or a control system. More specifically, the method may include a software program and/or algorithm that is stored in the memory of a network node (and/or control system) and when executed by the processing circuitry may perform the operations indicated by the recited steps. In some embodiments, the method may be embodied in a non-transitory computer readable medium that stores instructions executable by processing circuitry of a network node and/or a control system, wherein the instructions executed by the processing circuitry perform operations including the steps of the disclosed method of the third solution.

In one embodiment, a method performed by a network node for conducting de-authorization of an IAB node according to a fourth solution is disclosed. The method includes receiving, by a IAB-MT associated with the IAB node from a non-F1 terminating donor, a de-authorization indication message that indicates that the IAB node and/or the IAB-MT has been de-authorized to operate in a network; sending, by the IAB-MT in response to receiving the de-authorization indication message, a node-internal signaling message indicating that the IAB node and/or the IAB-MT has been de-authorized to an IAB-DU associated with the IAB node; and sending, by the IAB-DU to an F1 terminating donor, a request for releasing an F1 connection established between the IAB-DU and the F1 terminating donor. In some embodiments, the operations of the disclosed method may be executed by a network node and/or a control system. More specifically, the method may include a software program and/or algorithm that is stored in the memory of a network node (and/or control system) and when executed by the processing circuitry may perform the operations indicated by the recited steps. In some embodiments, the method may be embodied in a non-transitory computer readable medium that stores instructions executable by processing circuitry of a network node and/or a control system, wherein the instructions executed by the processing circuitry perform operations including the steps of the disclosed method of the fourth solution.

### BRIEF DESCRIPTION OF THE DRAWINGS

The accompanying drawings, which are included to provide a further understanding of the disclosure and are incorporated in and constitute a part of this application, illustrate certain non-limiting embodiments of the present disclosure. In the drawings:

FIG. 1 depicts example signaling related to a successful operation of an IAB transport migration management triggered by the F1-terminating donor;

FIG. 2 depicts example signaling related to an unsuccessful operation of an IAB transport migration management triggered by the F1-terminating donor;

FIG. 3 depicts example signaling related to a successful operation of an IAB transport migration modification;

FIG. 4 depicts example signaling related to a successful operation of a UE context modification;

FIG. 5 is a block diagram of an example IAB system architecture according to some embodiments;

FIG. 6 is a signaling diagram of an example first solution for conducting a deauthorization of an IAB node according to some embodiments;

FIG. 7 is a signaling diagram of an example second solution for conducting a deauthorization of an IAB node according to some embodiments;

FIG. 8 is a signaling diagram of an example third solution for conducting a deauthorization of an IAB node according to some embodiments;

FIG. 9 is a signaling diagram of an example fourth solution for conducting a deauthorization of an IAB node according to some embodiments;

FIG. 10 is a flow chart illustrating operations for executing a first solution for conducting a deauthorization of an IAB node according to some embodiments;

FIG. 11 is a flow chart illustrating operations for executing a second solution for conducting a deauthorization of an IAB node according to some embodiments;

FIG. 12 is a flow chart illustrating operations for executing a third solution for conducting a deauthorization of an IAB node according to some embodiments;

FIG. 13 is a flow chart illustrating operations for executing a fourth solution for conducting a deauthorization of an IAB node according to some embodiments;

FIG. 14 is a block diagram of an example control system configured to perform operations related to the deauthorization of an IAB node according to some embodiments;

FIG. 15 is a block diagram of a communication system in accordance with some embodiments;

FIG. 16 is a block diagram of a user equipment in accordance with some embodiments;

FIG. 17 is a block diagram of a network node in accordance with some embodiments;

FIG. 18 is a block diagram of a host computing device in accordance with some embodiments, and

FIG. 19 is a block diagram of a virtualization environment in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

The disclosed subject matter pertains to IAB node transport migration management. When the IAB-MT and IAB-DU are connected to different donors, the traffic between the IAB-DU's donor (e.g., an F1 terminating donor) and the IAB-DU is forwarded via the network under the IAB-MT's donor (e.g., a non-F1 terminating donor), and the IAB-MT. In other words, the IAB-MT's donor serves as a proxy that forwards the traffic between the IAB-DU and its donor. This forwarding is ensured by coordination between the IAB-DU's donor and the IAB-MT's donor. In Release-17, 3GPP has specified two procedures, one initiated by the IAB-DU's donor (herein referred to as the F1-terminating donor of the IAB node) and the IAB-MT's donor (herein referred to as the non-F1-terminating donor of the IAB node). The normative text describing the two procedures is presented below.

The disclosed subject matter is also related to operations pertaining to IAB Transport Migration Management. The purpose of the IAB Transport Migration Management procedure is to exchange information between the F1-terminating IAB-donor and the non-F1-terminating IAB-donor of a boundary IAB-node, for the purpose of managing the migration of the boundary and descendant IAB-node traffic between the topologies managed by the two IAB-donors.

The procedure is applicable to inter-donor partial migration, inter-donor Radio Link Failure (RLF) recovery and inter-donor topology redundancy cases. The procedure is initiated by the F1-terminating IAB-donor of the boundary IAB-node. The procedure can be used to set up, modify and release (e.g., for the purpose of revoking) the resources under the non-F1-terminating IAB-donor used for serving the offloaded traffic. The procedure uses UE-associated signaling.

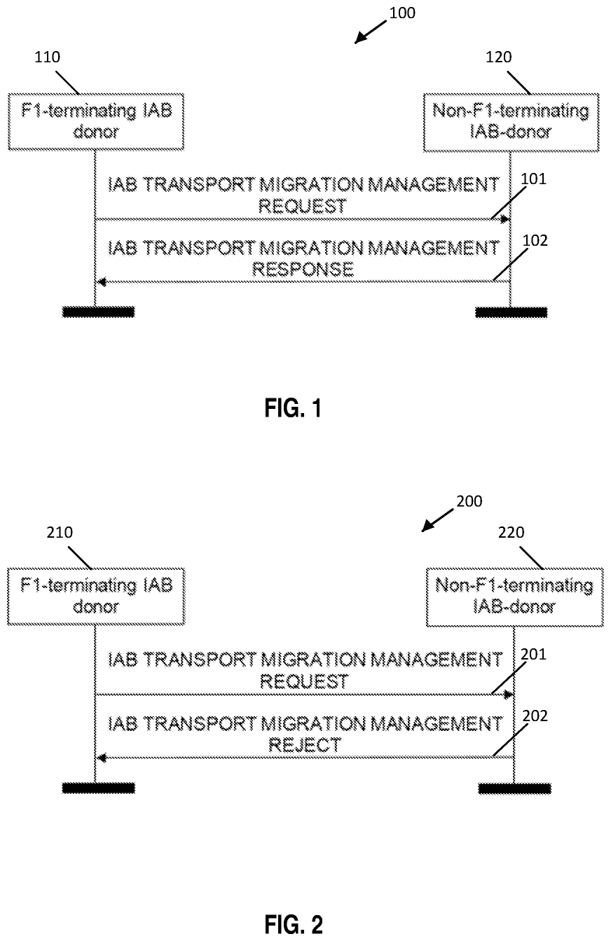

FIG. 1 shows an example IAB transport migration management request that is triggered by the F1-terminating IAB-donor during a successful operation. As shown in diagram 100 of FIG. 1, an F1-terminating IAB-donor 110 initiates the procedure by sending the IAB TRANSPORT MIGRATION MANAGEMENT REQUEST message 101 to the non-F1-terminating IAB-donor 120. The non-F1-terminating IAB-donor 120 may respond with the IAB TRANSPORT MIGRATION MANAGEMENT RESPONSE message 102 by indicating:
Traffic accepted for offloading, within the Traffic Added List information element (IE);
Already offloaded traffic accepted for modification, within the Traffic Modified List IE;
Traffic not accepted for offloading, within the Traffic Not Added List IE;
Already offloaded traffic not accepted for modification within the Traffic Not Modified List IE.

If the Traffic To Be Released Information IE is contained in the IAB TRANSPORT MIGRATION MANAGEMENT REQUEST message 101, the non-F1-terminating IAB-donor 120 should release all offloaded traffic if the All Traffic Indication IE in the Traffic to Be Released Information IE is set to “true”, or release only the offloaded traffic indicated by the Traffic to Be Released Item IE in the Traffic to Be Released Information IE.

If the IAB TRANSPORT MIGRATION MANAGEMENT REQUEST message 101 contains the Traffic to Be Released Information IE, the non-F1-terminating IAB-donor 120 shall include the Traffic Released List IE in the IAB TRANSPORT MIGRATION MANAGEMENT RESPONSE message 102.

If the IAB TRANSPORT MIGRATION MANAGEMENT REQUEST message 101 contains the IAB IPv4 Addresses Requested IE or the IAB IPv6 Request Type IE in the IAB TNL Address Request IE, the non-F1-terminating IAB-donor 120 shall, if supported, provide the allocated TNL address via the IAB TNL Address Response IE in the IAB TRANSPORT MIGRATION MANAGEMENT RESPONSE message 102. If the IAB TRANSPORT MIGRATION MANAGEMENT REQUEST message 101 contains the IAB TNL Address To Remove List IE in the IAB TNL Address Request IE, the non-F1-terminating IAB-donor 120 shall consider that the TNL address(es) are no longer used by the F1-terminating IAB-donor 110.

If the IAB TNL Address Exception IE is contained in the IAB TRANSPORT MIGRATION MANAGEMENT REQUEST message 101, the non-F1-terminating IAB-donor 120 shall, if supported, configure the related IAB-donor-DU to enable traffic re-routing over the inter-IAB-donor-DU tunnel.

If the IAB QoS Mapping Information IE is contained in the IAB TRANSPORT MIGRATION MANAGEMENT RESPONSE message 102, the F1-terminating IAB-donor 110, shall, if supported, use it to set Differentiated Services Code Point (DSCP) and/or IPv6 flow label fields for the downlink Internet protocol (IP) packets of the offloaded traffic.

FIG. 2 shows an example IAB transport migration management request that is triggered by the F1-terminating IAB-donor during an unsuccessful operation. As shown in diagram 200 of FIG. 2, if a non-F1-terminating IAB-donor 220 is not able to accept any traffic for offloading or modification from a F1-terminating IAB-donor 210, or a failure occurs during the IAB Transport Migration Management procedure, the non-F1-terminating IAB-donor 220 sends the IAB TRANSPORT MIGRATION MANAGEMENT REJECT message 202 with an appropriate cause value to the F1-terminating IAB-donor.

### IAB Transport Migration Modification

The purpose of the IAB Transport Migration Modification procedure is to modify the backhaul information of the offloaded traffic in the topology of the non-F1-terminating IAB-donor of a boundary IAB-node. The procedure can also be used to release the resources under the non-F1-terminating IAB-donor used for serving the offloaded traffic.

The procedure is applicable to inter-donor partial migration, inter-donor RLF recovery, and inter-donor topology redundancy cases. The procedure is initiated by the non-F1-terminating IAB-donor of the boundary IAB-node. The procedure uses UE-associated signaling.

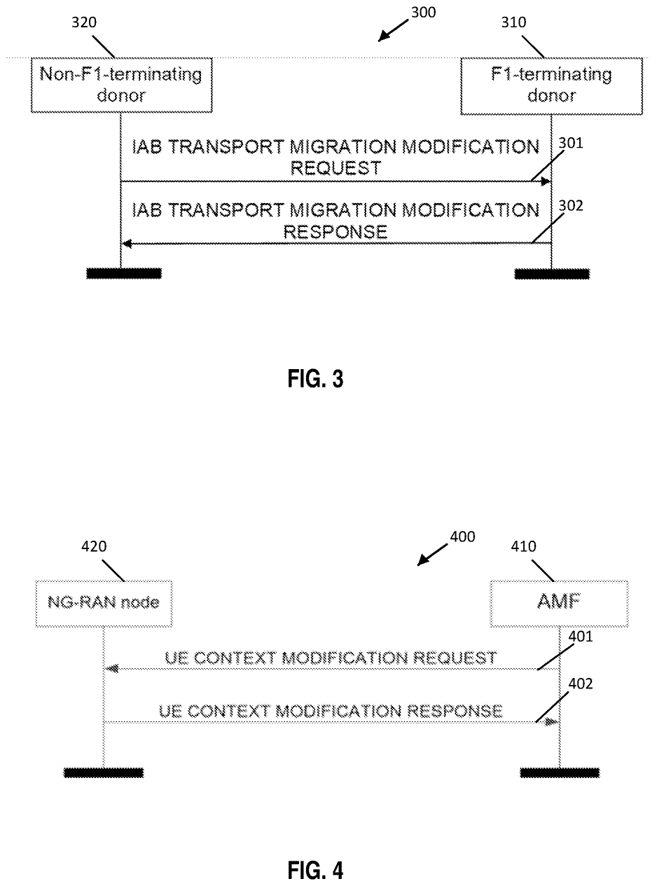

FIG. 3 shows an example IAB transport migration modification during a successful operation. As shown in diagram 300 of FIG. 3, a non-F1-terminating IAB-donor 320 initiates the procedure by sending the IAB TRANSPORT MIGRATION MODIFICATION REQUEST message 301 to the F1-terminating IAB-donor 310. The F1-terminating IAB-donor 310 responds with the IAB TRANSPORT MIGRATION MODIFICATION RESPONSE message 302.

If the Traffic Required To Be Modified List IE is contained in the IAB TRANSPORT MIGRATION MODIFICATION REQUEST message 301, the F1-terminating IAB-donor 310 shall update the backhaul information in non-F1-terminating topology for each traffic indicated in the list, and include the Traffic Required Modified List IE in the IAB TRANSPORT MIGRATION MODIFICATION RESPONSE message 302. If the Traffic To Be Released Information IE is contained in the IAB TRANSPORT MIGRATION MODIFICATION REQUEST message 301, the F1-terminating IAB-donor 310 shall consider that all offloaded traffic will be released by the non-F1-terminating IAB-donor 320 if the All Traffic Indication IE in the Traffic to Be Released Information IE is set to “true”, or that only the traffic indicated by the Traffic to Be Released Item IE will be released by the non-F1-terminating IAB-donor 320. If the IAB TRANSPORT MIGRATION MODIFICATION REQUEST message 301 contains the Traffic To Be Released Information IE, the F1-terminating IAB-donor 310 shall include the Traffic Released List IE in the IAB TRANSPORT MIGRATION MODIFICATION RESPONSE message 302. If the IAB TNL Address To Be Added IE is contained in the IAB TRANSPORT MIGRATION MODIFICATION REQUEST message 301, the F1-terminating IAB-donor 310 shall allocate the TNL address(es) contained in this IE to the boundary IAB-node or the descendant IAB-nodes. If the IAB TNL Address To Be Released IE is contained in the IAB TRANSPORT MIGRATION MODIFICATION REQUEST message 301, the F1-terminating IAB-donor 310 shall release the TNL address(es) contained in this IE for the boundary IAB-node or the descendant IAB-nodes. If the IAB QoS Mapping Information IE is contained in the IAB TRANSPORT MIGRATION MODIFICATION REQUEST message 301, the F1-terminating IAB-donor 310, shall, if supported, use it to set DSCP and/or IPv6 flow label fields for the downlink IP packets of the offloaded traffic.

### IAB Node Authorization Handling

Furthermore, during the Release-18 work, it is specified that a mobile IAB-node (mIAB) may be moved from the “authorized” to the “not authorized” status, e.g., due to subscription data change. The purpose of the UE Context Modification procedure is to partly modify the established UE context. The procedure uses UE-associated signaling. Notably, FIG. 4 shows an example UE context modification during a successful operation.

As shown in diagram 400 of FIG. 4, upon receipt of the UE CONTEXT MODIFICATION REQUEST message 401 from an Access and Mobility Management Function (AMF) 410, a NG-RAN node 420 shall:
i) if supported, store the received IAB Authorization information in the UE context. If the IAB Authorized IE is set to “not authorized” for an IAB-MT, the NG-RAN node 420 shall, if supported, initiate actions to ensure that the IAB node will not serve any UE(s), or
ii) if supported, store the received Mobile IAB Authorization information in the UE context. If the Mobile IAB Authorized IE is set to “not authorized” for an mobile IAB-MT, the NG-RAN node 420 shall, if supported, initiate actions to ensure that the mobile IAB node will not serve any UE(s).

If the Security Key IE is included in the UE CONTEXT MODIFICATION REQUEST message 401, the NG-RAN node 420 shall store it and perform AS key re-keying.

In Release-16, 3GPP specified the IAB-node orderly release, that may comprise the removal of the F1 connection of the IAB-DU and IAB-MT deregistration. In some examples, for an IAB-node orderly release, the IAB-donor-CU can remove the F1 interface connection to the IAB-DU without releasing the IAB-MT. If the IAB-MT needs to be released, IAB-MT will perform the deregistration procedure. If both F1 interface and IAB-MT need to be released, the IAB-donor-CU should remove the F1 interface to the IAB-DU before it releases the collocated IAB-MT. The deregistration procedure is the same as the UE deregistration procedure. The IAB-donor-CU hands over the UEs or child IAB-nodes currently connected to the IAB-node's cell(s) to another cell(s), or releases the UEs and may stop accepting incoming handovers or connections to the IAB-node that is about to be released. The IAB-donor-CU may also update/release the backhaul (BH) radio link control (RLC) channels in the intermediate hops. At this point, the F1 interface will be released and the corresponding Stream Control Transmission Protocol (SCTP) associations will be removed.

As indicated above, the disclosed subject matter provides a solution for notifying the donor central unit (CU) serving the IAB-DU/mIAB-DU that the IAB-MT/mIAB-MT is not authorized for operating in the RAN, so that the donor CU serving the IAB-DU/mIAB-DU can hand over the UEs served by the IAB-node to other RAN nodes, and remove the F1 connection (both user plane and control plane) to the mIAB-DU and release the resources for the F1 connection. Some of the embodiments contemplated herein will now be described more fully with reference to the accompanying drawings. Embodiments are provided by way of example to convey the scope of the subject matter to those skilled in the art.

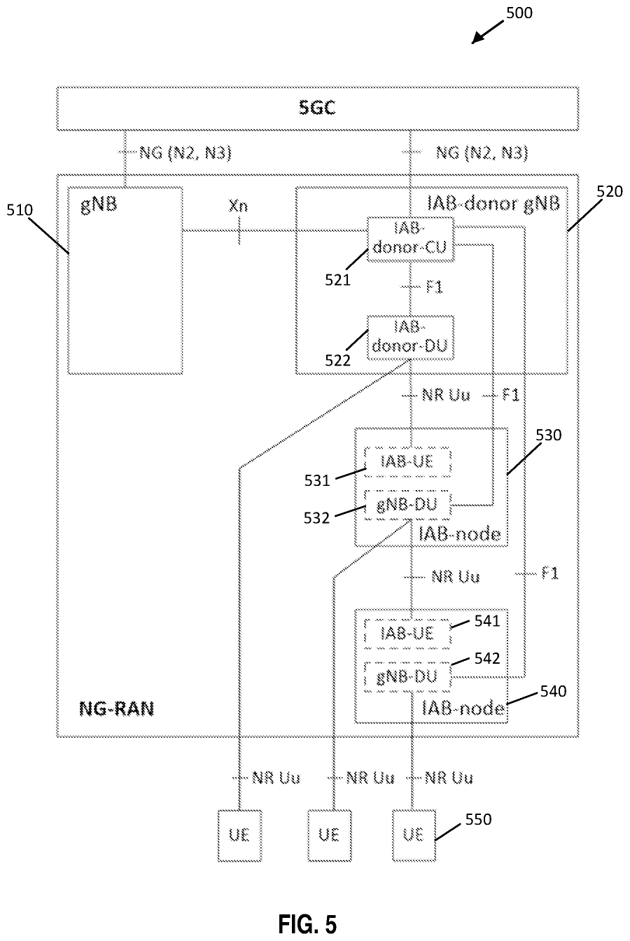

FIG. 5 illustrates a block diagram of an example IAB architecture as described in TS 23.501 clause 5.35. The IAB-node is stationary in Release-16/17. The IAB-node is mobile in Release-18 (e.g., can move from one IAB-donor gNB to another IAB-donor gNB). As shown in diagram 500 of FIG. 5, the IAB architecture may include at least one gNB 510, an IAB donor gNB 520, IAB nodes 530 and 540, and a plurality of UEs 550. Notably, IAB-donor gNB 520 includes an IAB donor-CU component 521 and a IAB donor-DU component 522. Similarly, each of IAB nodes 530 and 540 includes an IAB-UE component 531, 541 and a gNB-DU component 532, 542. Notably, FIG. 5 depicts a number of F1 connections and/or interfaces established between the IAB donor-CU and the various DU components.

The present disclosure provides for a number of disclaimers including i) unless stated otherwise, herein, all considerations for the IAB-node equally apply to mobile IAB-node as well, ii) unless stated otherwise, herein, all considerations for the IAB-MT equally apply to mIAB-MT as well, iii) unless stated otherwise, herein, all considerations for the IAB-DU equally apply to mIAB-DU as well, iv) the terms “donor gNB-CU”, “donor CU” and “CU” are used interchangeably, v) the terms “unauthorized IAB node”, “IAB node not authorized”, and “de-authorized IAB node” are used interchangeably, vi) the solution proposed in the present disclosure applies to Universal Mobile Telecommunications System (UMTS), long term evolution (LTE), and new radio (NR) as well as future Radio Access Technologies (RATs), such as 6G, vii) the donor-gNB includes a donor-gNB-CU part and a donor-gNB-DU part (as related to control signaling, donor-gNB means the same thing as donor-gNB-CU in the present disclosure), and viii) the provided signaling examples and references to messages used herein are non-limiting, meaning that other messages (e.g., newly defined ones) may be used instead.

In some embodiments, the disclosed subject matter pertains to methods for the IAB-MT's donor (e.g., a non-F1 terminating donor) to inform the IAB-DU's donor (e.g., a F1 terminating donor) that the IAB-MT has been deauthorized. For example, disclosed methods pertain to Xn Application protocol (XnAP) signaling (e.g., the IAB Transport Migration Modification and IAB Transport Migration Management XnAP procedures) or Radio Resource Control (RRC) signaling.

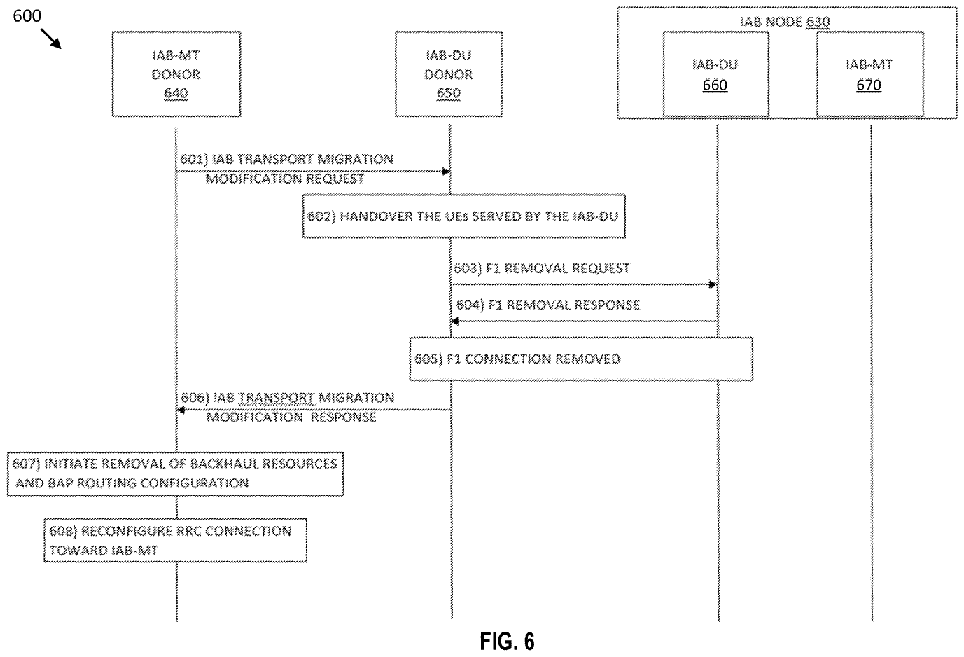

In some embodiments, a first solution (i.e., “Solution 1”) is depicted in diagram 600 of FIG. 6 wherein the IAB-MT's donor includes a non-F1 terminating donor 640. Notably, non-F1 terminating donor 640 receives an “IAB-node de-authorized” indication for the UE Context associated with the IAB-MT (e.g., IAB-MT 670). In some embodiments, non-F1 terminating donor 640 includes an indication that the IAB node 630 and/or its IAB-MT 670 is de-authorized in the XnAP IAB TRANSPORT MIGRATION MODIFICATION REQUEST message 601 sent to the IAB-DU's donor (e.g., F1 terminating donor 650). The request message 601 may also optionally contain the existing Traffic To Be Released Information IE, by which the non-F1 terminating donor 640 requests to release the configurations for forwarding the F1 traffic between the F1 terminating donor 650 and the IAB-DU (e.g., IAB-DU 660) via the non-F1 terminating donor 640.

In some embodiments, upon receiving the “IAB-node de-authorized” indication from the non-F1 terminating donor 640, the F1 terminating donor 650 understands that the IAB-node 630 can no longer operate in the network. Then, the F1 terminating donor 650 first hands over (e.g., see block 602) the UEs served by the IAB-DU to other RAN nodes (not shown). After all the UEs have been handed over, the F1 terminating donor 650 initiates the F1 Removal (i.e., F1 connection removal) towards the IAB-DU 660. The F1 removal is initiated by sending the existing F1 REMOVAL REQUEST message 603 to the IAB-DU 660. The IAB-DU 660 replies with the F1 REMOVAL RESPONSE message 604, and the F1 connection between the F1 terminating donor 650 and the IAB-DU 660 is this removed (see block 605).

After the F1 terminating donor 650 has received the F1 REMOVAL RESPONSE message 604, it responds to the XnAP IAB TRANSPORT MIGRATION MODIFICATION REQUEST message 601 from the non-F1 terminating donor 640, by sending the XnAP IAB TRANSPORT MIGRATION MODIFICATION RESPONSE message 606 to the non-F1 terminating donor 640, to confirm the reception of the indication and confirm the release of configurations for forwarding the F1 traffic between the F1 terminating donor 650 and the IAB-DU 660 via the non-F1 terminating donor 640.

Based on the indication from the F1 terminating donor 650 that the F1 interface towards the IAB-DU 660 has been removed, the non-F1 terminating donor 640 may initiate in its network the removal of the backhaul resources and Backhaul Adaptation Protocol (BAP) routing configuration at the ancestor nodes of the de-authorized IAB-MT (see block 607). The non-F1 terminating donor 640 may reconfigure the RRC connection towards IAB-MT 670 by removing backhaul related configurations (see block 608). In some embodiments, the backhaul related configurations may include one or more of the BAP address, TNL address, and default BAP configuration. This may be an implicit indication to the IAB-MT 670 that it is de-authorized, or the non-F1 terminating donor 640 can send such an indication to the IAB-MT 670 explicitly via the RRC. The Access Stratum (AS) layer in IAB-MT 670 may inform the Non Access Stratum (NAS) layer of the de-authorization. The NAS layer may trigger the deregistration of the IAB-MT 670 or remove of the PDU session for operation and maintenance (O&M) access if there is such deployed.

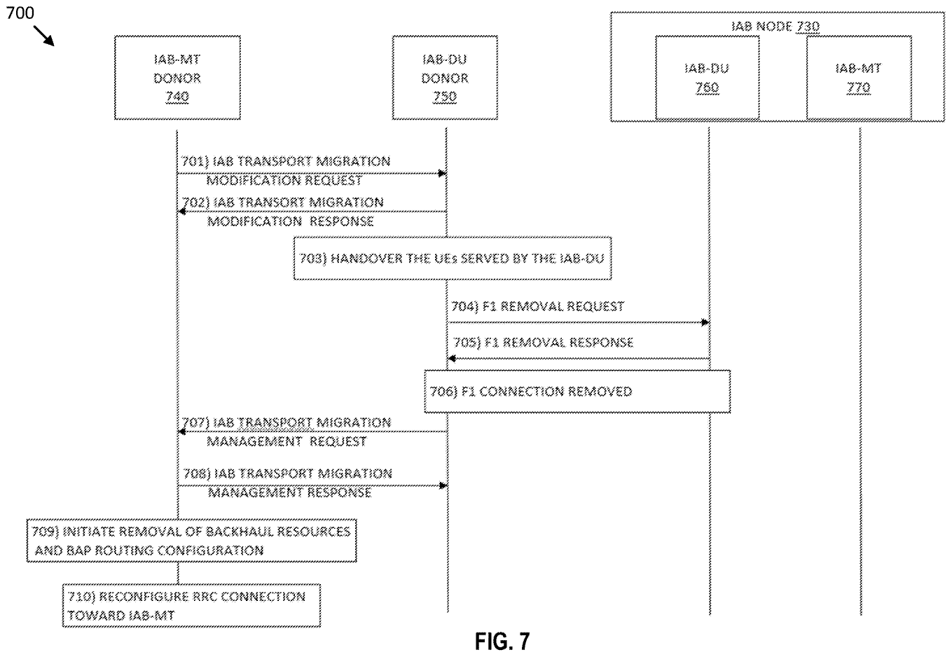

In some embodiments, a second solution (i.e., “Solution 2”) is depicted in diagram 700 of FIG. 7 wherein the IAB-MT's donor is a non-F1 terminating donor 740. Notably, non-F1 terminating donor 740 receives an “IAB-node de-authorized” indication for the UE Context associated with the IAB-MT (e.g., IAB-MT 770). In some embodiments, non-F1 terminating donor 740 includes an indication that the IAB node 730 and/or its IAB-MT 770 is de-authorized in the XnAP IAB TRANSPORT MIGRATION MODIFICATION REQUEST message 701 sent to the IAB-DU's donor (e.g., F1 terminating donor 750). The message 701 may also optionally contain the existing Traffic To Be Released Information IE, by which the non-F1 terminating donor 740 requests to release the configurations for forwarding the F1 traffic between the F1 terminating donor 750 and the IAB-DU (e.g., IAB-DU 760) via the non-F1 terminating donor 740.

In some embodiments, upon receiving the “IAB-node de-authorized” indication (e.g., request message 701) from the non-F1 terminating donor 740, the F1 terminating donor 750 responds by sending the XnAP IAB TRANSPORT MIGRATION MODIFICATION RESPONSE message 702, to confirm the reception of the indication.

After handing over UEs connected via IAB-DU to other cells (see block 703), the F1 terminating donor 750 initiates the F1 Removal (i.e., F1 connection removal) towards the IAB-DU by sending the F1 REMOVAL REQUEST message (704) to the IAB-DU 760. The IAB-DU 760 replies with the F1 REMOVAL RESPONSE message 705, and the F1 connection between the F1 terminating donor 750 and the IAB-DU 760 is removed (see block 706).

In some embodiments, the F1 terminating donor 750 sends the XnAP IAB TRANSPORT MIGRATION MANAGEMENT REQUEST message 707 to the non-F1 terminating donor 740, to inform the non-F1 terminating donor 740 that the F1 connection with the IAB-DU 760 has been removed and to request from the non-F1 terminating donor 740 to release the backhaul resources used for serving the IAB-MT 770. In some embodiments, the non-F1 terminating donor 740 responds with the XnAP IAB TRANSPORT MIGRATION MANAGEMENT RESPONSE message 708 to the F1 terminating donor 750 to confirm the reception of the indication about F1 connection removal (i.e., request message 707).

In some embodiments, the non-F1 terminating donor 740 may initiate in its network the removal of the backhaul resources and BAP routing configuration at the ancestor nodes of the de-authorized IAB-MT 770 (see block 709). In some embodiments, the non-F1 terminating donor 740 may reconfigure the RRC connection towards IAB-MT 770 by removing backhaul related configurations (see block 710). In some embodiments, the backhaul related configurations may include one or more of the BAP address, TNL address, and default BAP configuration. This may be an implicit indication to the IAB-MT 770 that it is de-authorized, or the non-F1 terminating donor 740 can send such an indication to the IAB-MT 770 explicitly via the RRC. The Access Stratum (AS) layer in IAB-MT 770 may inform the Non Access Stratum (NAS) layer of the de-authorization. The NAS layer may trigger the deregistration of the IAB-MT 770 or remove of the PDU session for operation and maintenance (O&M) access if there is such deployed.

As described herein, the difference between the second solution and the first solution is that, in the first solution, after receiving the “IAB de-authorized” indication, the F1 terminating donor initially hands over the UEs and removes the F1 connection with the IAB-DU, and then responds to the non-F1 terminating donor indicating that F1 connection with the IAB-DU has been removed. In the second solution, after receiving the “IAB de-authorized” indication, the F1 terminating donor first acknowledges to the non-F1 terminating donor the reception of this message. Afterwards, the F1 terminating donor hands over the UEs and removes the F1 connection, and then indicates to the non-F1 terminating donor that the F1 connection with the IAB-DU has been removed.

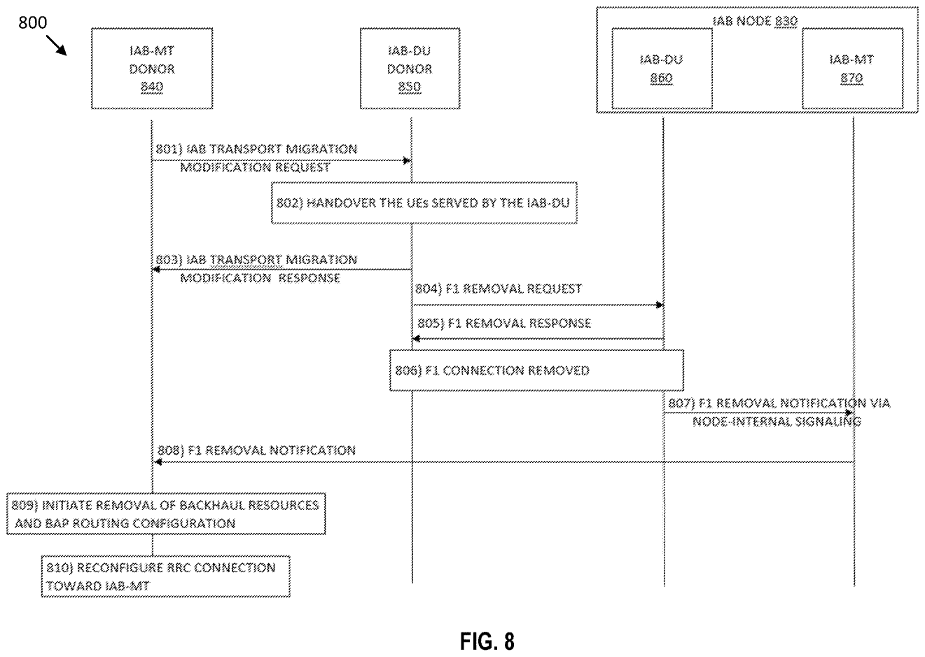

In some embodiments, a third solution (i.e., “Solution 3”) is depicted in diagram 800 of FIG. 8 wherein the IAB-MT's donor is a non-F1 terminating donor 840. Notably, non-F1 terminating donor 840 receives an “IAB-node de-authorized” indication for the UE Context associated with the IAB-MT (e.g., IAB-MT 870). In some embodiments, non-F1 terminating donor 840 includes an indication that the IAB node 830 and/or its IAB-MT 870 is de-authorized in the XnAP IAB TRANSPORT MIGRATION MODIFICATION REQUEST message 801 sent to the IAB-DU's donor (e.g., F1 terminating donor 850). The message 801 may also optionally contain the existing Traffic To Be Released Information IE, by which the non-F1 terminating donor 840 requests to release the configurations for forwarding the F1 traffic between the F1 terminating donor 850 and the IAB-DU (e.g., IAB-DU 860) via the non-F1 terminating donor 840.

In some embodiments, upon receiving the “IAB-node de-authorized” indication (e.g., request message 801) from the non-F1 terminating donor 840, the F1 terminating donor 850 is configured to initiate the handover of UEs connected via IAB-DU 860 to other cells (see block 802). After conducting the handover procedure, F1 terminating donor 850 may send the XnAP IAB TRANSPORT MIGRATION MODIFICATION RESPONSE message 803, to confirm the reception of the received indication 801. Moreover, the F1 terminating donor 850 may initiate the F1 Removal (i.e., F1 connection removal) towards the IAB-DU 860 by sending the F1 REMOVAL REQUEST message 804 to the IAB-DU 860. The IAB-DU 860 replies with the F1 REMOVAL RESPONSE message 805, and the F1 connection between the and the IAB-DU 860 is removed (see block 806).

Once the F1 connection is removed, the IAB-DU 860 can inform the IAB-MT 870 (e.g., by means of node-internal signaling 807) about the successful F1 removal. Afterwards, the IAB-MT 870 may inform the non-F1 terminating donor 840 that the F1 connection has been successfully removed via notification 808, instead of the F1 terminating donor 850 having to inform the non-F1 terminating donor 840 of the same.

In some embodiments, the non-F1 terminating donor 840 may initiate in its network the removal of the backhaul resources and BAP routing configuration at the ancestor nodes of the de-authorized IAB-MT 870 (see block 809). In some embodiments, the non-F1 terminating donor 840 may reconfigure the RRC connection towards IAB-MT 870 by removing backhaul related configurations (see block 810). In some embodiments, the backhaul related configurations may include one or more of the BAP address, TNL address, and default BAP configuration. This may be an implicit indication to the IAB-MT 870 that it is de-authorized, or the non-F1 terminating donor 840 can send such an indication to the IAB-MT 870 explicitly via the RRC. The Access Stratum (AS) layer in IAB-MT 870 may inform the Non Access Stratum (NAS) layer of the de-authorization. The NAS layer may trigger the deregistration of the IAB-MT 870 or remove of the PDU session for operation and maintenance (O&M) access if there is such deployed.

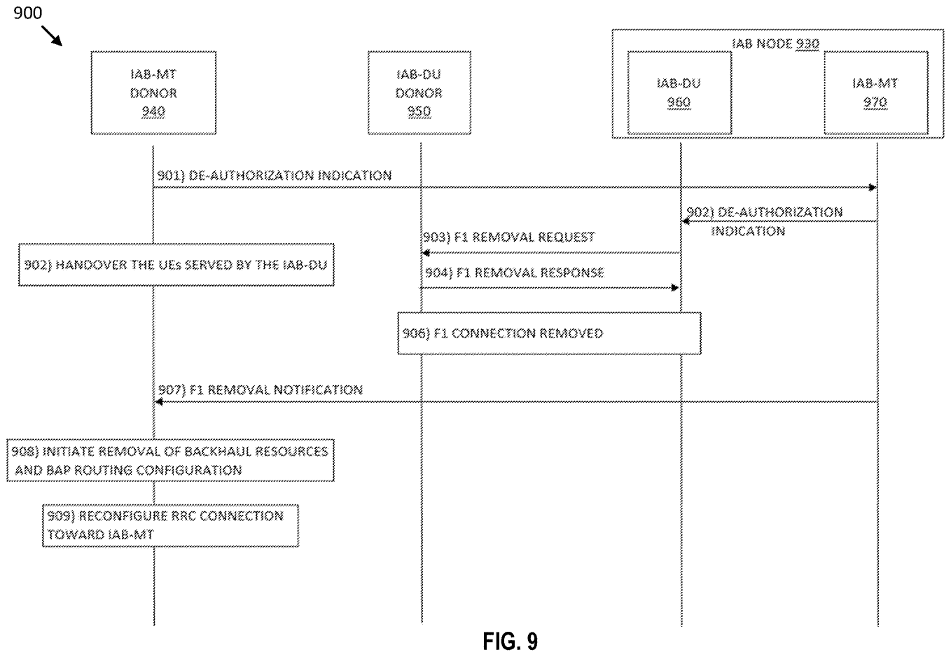

In some embodiments, a fourth solution (i.e., “Solution 4”) is depicted in diagram 900 of FIG. 9 wherein the IAB-MT's donor is a non-F1 terminating donor 940. As shown in FIG. 9, the non-F1 terminating donor 940 sends to the IAB-MT 970 the “de-authorized” indication 901. Afterwards, the IAB-MT 970 informs the IAB-DU 960 about the de-authorization (e.g., by means of node-internal signaling 902). The reception of this indication from the IAB-MT 970 triggers the IAB-DU 960 to initiate the F1 Removal procedure (blocks 903-904) towards and/or with F1 terminating donor 950. After the F1 connection removal (see block 906), either the CU of IAB-DU 960 or the IAB-MT 970 may inform the non-F1 terminating donor 940 that the F1 connection has been removed via notification 907.

In some embodiments, the non-F1 terminating donor 940 may initiate in its network the removal of the backhaul resources and BAP routing configuration at the ancestor nodes of the de-authorized IAB-MT 970 (see block 908). In some embodiments, the non-F1 terminating donor 940 may reconfigure the RRC connection towards IAB-MT 970 by removing backhaul related configurations (see block 909). In some embodiments, the backhaul related configurations may include one or more of the BAP address, TNL address, and default BAP configuration. This may be an implicit indication to the IAB-MT 970 that it is de-authorized, or the non-F1 terminating donor 940 can send such an indication to the IAB-MT 970 explicitly via the RRC. The Access Stratum (AS) layer in IAB-MT 970 may inform the Non Access Stratum (NAS) layer of the de-authorization. The NAS layer may trigger the deregistration of the IAB-MT 970 or remove of the PDU session for operation and maintenance (O&M) access if there is such deployed.

In some embodiments, pertaining to all the solutions where the non-F1 terminating donor (e.g., donor of IAB-MT) sends the “de-authorized” indication to the F1 terminating donor (e.g., donor of IAB-DU) in an XnAP message, in the response message, the F1 terminating donor may also indicate to the non-F1 terminating donor that the F1 connection to the IAB-DU has been removed (similar to the first solution, where the F1 terminating donor responds to non-F1 terminating donor only after the F1 connection removal) or that the F1 connection will be removed (as in second solution, where the F1 terminating donor responds to non-F1 terminating donor before the F1 connection removal, and then, after the F1 connection/interface to the IAB-DU has been removed, indicates the same to the non-F1 terminating donor). In the second solution, the IAB-DU's donor can use the same IE to send the “F1 will be removed” indication to the IAB-MT's donor.

As explained above, after the F1 connection between the F1 terminating donor and the IAB-DU has been removed, the non-F1 terminating donor can release the backhaul resources towards the IAB-MT and optionally de-register the IAB-MT from the network.

In some embodiments, where there is no XnAP connection between the non-F1 terminating donor and the F1 terminating donor, the “de-authorized” indication and the response messages mentioned herein may be sent via one or more AMFs, e.g., via NGAP signaling.

In some embodiments, the messages are passed from the non-F1 terminating donor via the AMF to the F1 terminating donor and vice versa, transparently via the AMF.

In some embodiments, instead of non-F1 terminating donor informing the F1 terminating donor that the node is de-authorized, it is the AMF that informs the F1 terminating donor.

In some embodiments, if the two donors are served by different AMFs, then inter-AMF signaling would be needed as well.

The methods proposed in the present disclosure are described on the scenario of IAB-node deauthorization (i.e., IAB-node authorization state is changed from authorized to not authorized). However, these methods can also be applied for the opposite scenario, where the IAB node becomes authorized (after being deauthorized for a while, but the IAB-MT remains registered in the network). In that scenario, the same signaling (e.g., XnAP or RRC) used for the de-authorization case can be used for the authorization case, but with a somewhat different sequence of steps. For example, the IAB-MT's donor (e.g., the non-F1 terminating donor) sends the “authorized” indication to the IAB-DU's (former and future) donor (e.g., former and future F1 terminating donor), and IAB-DU responds in one of the ways described in Solutions 1, 2, 3, and/or 4 as described above. Further, the IAB-MT's donor also sends the “authorized” indication to the IAB-node and sets up one or more BH RLC channels between the IAB-MT and its parent node. Afterwards, the reception of the “authorized” indication triggers the IAB-node to initiate an F1 connection setup from the IAB-DU towards the donor (e.g., the donor that served the F1 connection of the node when it was previously authorized).

As described herein, the present disclosure can be implemented as a single-connected IAB node whose IAB-MT and IAB-DU are served by different donors. In some embodiments, the disclosed subject matter can be applied to dual-connected IAB nodes as well, provided that the RAN node terminating the IAB-MT's RRC connection is different from the RAN node terminating the IAB-DU's F1 connection, or any other scenario where this is the case, for example in the IAB Inter-CU Backhaul RLF recovery for single connected IAB-node scenario.

In some embodiments, the disclosed subject matter may be implemented in XnAP. For example, an IAB TRANSPORT MIGRATION MODIFICATION REQUEST message can be sent by a non-F1-terminating IAB-donor to an F1-terminating IAB-donor of a boundary IAB-node, for the purpose of modifying or releasing (e.g., for the purpose of revoking) the configuration for the migrated traffic of boundary IAB-node or descendant IAB-node. In some embodiments, an IAB Authorization Status IE is shown below in Table 1 (e.g., see last entry), which provides a representative example of an IAB Transport Migration Modification Request message. Moreover, associated Table 2 specifies and defines a plurality of range bound parameters that are included in Table 1.

TABLE 1

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| F1-Terminating IAB- | M | | NG-RAN node | This IE | YES | reject |
| donor UE XnAP ID | | | UE XnAP ID | refers to | | |
| | | | 9.2.3.16 | the Source | | |
| | | | | NG-RAN | | |
| | | | | node UE | | |
| | | | | XnAP ID | | |
| | | | | or to the | | |
| | | | | M-NG- | | |
| | | | | RAN node | | |
| | | | | UE XnAP | | |
| | | | | ID, or to | | |
| | | | | the S-NG- | | |
| | | | | RAN node | | |
| | | | | UE XnAP | | |
| | | | | ID. | | |
| Non-F1-Terminating | M | | NG-RAN node | This IE | YES | reject |
| IAB-donor UE XnAP | | | UE XnAP ID | refers to | | |
| ID | | | 9.2.3.16 | the Target | | |
| | | | | NG-RAN | | |
| | | | | node UE | | |
| | | | | XnAP ID | | |
| | | | | or to the S- | | |
| | | | | NG-RAN | | |
| | | | | node UE | | |
| | | | | XnAP | | |
| | | | | ID, or to | | |
| | | | | the M-NG- | | |
| | | | | RAN node | | |
| | | | | UE XnAP | | |
| | | | | ID. | | |
| Traffic Required To | | 0 . . . 1 | | | YES | reject |
| Be Modified List | | | | | | |
| >Traffic Required | | 1 . . . <maxnoof | | | — | |
| To Be Modified | | TrafficIndexEntries> | | | | |
| Item | | | | | | |
| >>Traffic Index | M | | 9.2.2.80 | | — | |
| >>Non-F1- | M | | 9.2.2.83 | | — | |
| terminating | | | | | | |
| topology BH | | | | | | |
| information | | | | | | |
| Traffic To Be | O | | 9.2.2.84 | | YES | reject |
| Released Information | | | | | | |
| IAB TNL Address To | O | | IAB TNL | | YES | reject |
| Be Added | | | Address | | | |
| | | | Response | | | |
| | | | 9.2.2.86 | | | |
| IAB TNL Address To | | 0 . . . 1 | | | YES | reject |
| Be Released List | | | | | | |
| >IAB TNL Address | | 1 . . . | | | — | |
| To Be Released Item | | <maxnoofTLAsIAB> | | | | |
| >>IAB TNL | M | | 9.2.2.92 | | — | |
| Address | | | | | | |
| IAB Authorization | O | | 9.2.2.xxx | | YES | reject |
| Status | | | | | | |

TABLE 2

| Range bound | Explanation |
|---|---|
| maxnoofTrafficIndexEntries | Maximum no. of traffic offloaded to the |
| | non-F1-terminating IAB-donor. The value |
| | is 1024. |
| maxnoofTLAsIAB | Maximum total no. of IPv4 address(es), |
| | IPv6 address(es) and IPv6 address |
| | prefix(es) that can be requested in one |
| | procedure execution. The value is 1024. |

Further, Table 3 illustrates an example IAB Transport Migration Modification response message sent by the F1-terminating IAB-donor to the non-F1-terminating IAB-donor of a boundary IAB-node to acknowledge the update of configuration requested by the non-F1-terminating IAB-donor. In some embodiments, an IAB Authorization Status Acknowledgement IE is shown below in Table 3 (e.g., see last entry), which provides a representative example of an IAB Transport Migration Modification Response message. Moreover, associated Table 4 specifies and defines a number of range bound parameters that are included in Table 3.

TABLE 3

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| F1-Terminating IAB- | M | | NG-RAN node | This IE | YES | reject |
| donor UE XnAP ID | | | UE XnAP ID | refers to | | |
| | | | 9.2.3.16 | the Source | | |
| | | | | NG-RAN | | |
| | | | | node UE | | |
| | | | | XnAP ID | | |
| | | | | or to the | | |
| | | | | M-NG- | | |
| | | | | RAN node | | |
| | | | | UE XnAP | | |
| | | | | ID, or to | | |
| | | | | the S-NG- | | |
| | | | | RAN node | | |
| | | | | UE XnAP | | |
| | | | | ID. | | |
| Non-F1-Terminating | M | | NG-RAN node | This IE | YES | reject |
| IAB-donor UE XnAP | | | UE XnAP ID | refers to | | |
| ID | | | 9.2.3.16 | the Target | | |
| | | | | NG-RAN | | |
| | | | | node UE | | |
| | | | | XnAP ID | | |
| | | | | or to the S- | | |
| | | | | NG-RAN | | |
| | | | | node UE | | |
| | | | | XnAP | | |
| | | | | ID, or to | | |
| | | | | the M-NG- | | |
| | | | | RAN node | | |
| | | | | UE XnAP | | |
| | | | | ID. | | |
| Traffic Required | | 0 . . . 1 | | | YES | reject |
| Modified List | | | | | | |
| >Traffic Required | | 1 . . . | | | — | |
| Modified Item | | <maxnoof | | | | |
| | | TrafficIndexEntries> | | | | |
| >>Traffic Index | M | | 9.2.2.80 | | — | |
| Traffic Released List | | 0 . . . 1 | | | YES | reject |
| IE | | | | | | |
| >Traffic Released | | 1 . . . | | | — | |
| Item | | <maxnoof | | | | |
| | | TrafficIndexEntries> | | | | |
| >>Traffic Index | M | | 9.2.2.80 | | — | |
| >>BH Info List | O | | 9.2.2.99 | | — | |
| IAB Authorization | O | | ENUMERATED | | YES | reject |
| Status | | | (acknowledged, | | | |
| Acknowledgement | | | . . . ) | | | |

TABLE 4

| Range bound | Explanation |
|---|---|
| maxnoofTrafficIndexEntries | Maximum no. of traffic offloaded to the |
| | non-F1-terminating IAB-donor. The value |
| | is 1024. |

Table 5 below depicts an IAB Authorization Status IE that provides information about the authorization status of the mobile IAB node.

TABLE 5

| | | | | |
|---|---|---|---|---|
| IE/Group | | | IE type and | Semantics |
| Name | Presence | Range | reference | description |

| | | | |
|---|---|---|---|
| IAB | M | ENUMERATED | Indicates the |
| Authorization | | (authorized, not | mobile IAB |
| Status | | authorized, . . . ) | node |
| | | | authorization |
| | | | status. |

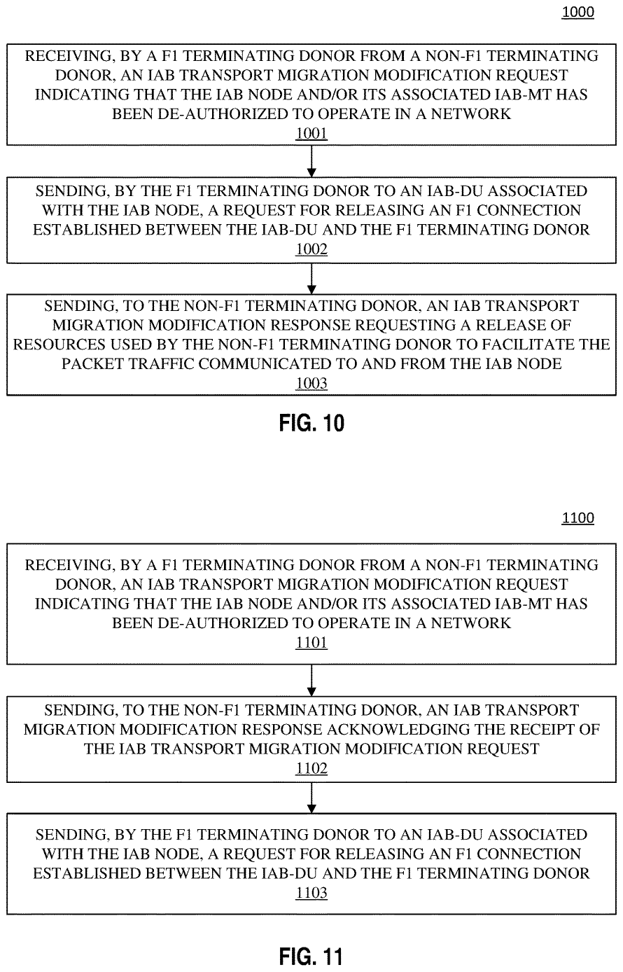

FIG. 10 is a flow chart of a method and/or process 1000 executed by one or more network nodes (e.g., a IAB-DU donor node, IAB-MT donor node, IAB node, F1 terminating node, non-F1 terminating node, IAB-DU, IAB-MT, and/or the like). In some embodiments, process 1000 may be a software algorithm that is stored in memory and executed by one or more processors (and/or processing circuitry) of a computer system hosting the one or more network nodes. In some embodiments, process 1000 may be executed to properly release and/or remove an F1 connection between an IAB-DU and a F1 terminating IAB donor (e.g., an IAB-DU donor) according to a first solution of the disclosed subject matter.

In block 1001, process 1000 includes receiving, by a F1 terminating donor from a non-F1 terminating donor, an IAB transport migration modification request indicating that the IAB node and/or its associated IAB-MT has been de-authorized to operate in a network. In some embodiments, a IAB-DU donor receives an IAB transport migration modification request from an IAB-M. The request serves as an indication that an IAB node has been de-authorized to operate in the network. In some embodiments, the IAB-DU may initiate the transfer and/or handover of UEs supported by the IAB-DU (associated with the de-authorized IAB node) to one or more other authorized IAB nodes and/or RAN nodes.

In block 1002, process 1000 includes sending, by the F1 terminating donor to an IAB-DU associated with the IAB node, a request for releasing an F1 connection established between the IAB-DU and the F1 terminating donor. In some embodiments, the IAB-DU donor sends a F1 removal request message to the IAB-DU. Upon receiving the request message, the IAB-DU may send to the IAB-DU donor a F1 removal response message that confirms receipt of the request message and/or the indicates the removal of the F1 connection.

In block 1003, process 1000 includes sending, to the non-F1 terminating donor, an IAB transport migration modification response requesting a release of resources used by the non-F1 terminating donor to facilitate the packet traffic communicated to and from the IAB node. In some embodiments, process 1000 includes sending, to the non-F1 terminating donor, an IAB transport migration modification response indicating that the F1 connection has been released or will be released. In some embodiments, the IAB-DU donor is configured to send to the IAB-MT donor a modification response message to confirm the reception of the de-authorization indication and confirm the release of configurations for forwarding the F1 traffic between the IAB-DU donor and the IAB-DU via the IAB-MT donor.

In some embodiments, the F1 terminating donor is a donor serving the IAB-DU. In some embodiments, the non-F1 terminating donor is a donor serving the IAB-MT. In some embodiments, the non-F1 terminating donor initiates a removal of backhaul resources associated with the IAB node in response to receiving the IAB transport migration modification response. In some embodiments, the non-F1 terminating donor initiates a removal of a Backhaul Adaptation Protocol, BAP, routing configuration at the IAB node and/or at one or more ancestor nodes of the IAB node in response to receiving the IAB transport migration modification response. In some embodiments, the F1 terminating donor transfers one or more UEs served by one or more cells configured on the IAB node to one or more cells served by one or more other IAB nodes and/or RAN nodes. In some embodiments, the F1 terminating donor is separate and distinct from the non-F1 terminating donor. In some embodiments, the IAB node comprises a mobile IAB node and wherein the non-F1 terminating donor is a Radio Resource Control, RRC, terminating IAB-donor. In some embodiments, the wherein the IAB node comprises a dual-connected IAB node. In some embodiments, the IAB-MT of the dual-connected IAB node is configured to support one or more of new radio, NR, dual connectivity (DC) and/or Evolved UMTS Terrestrial Radio Access, E-UTRA, NR DC.

FIG. 11 is a flow chart of a method and/or process 1000 executed by one or more network nodes (e.g., a IAB-DU donor node, IAB-MT donor node, IAB node, F1 terminating node, non-F1 terminating node, IAB-DU, IAB-MT, and/or the like). In some embodiments, process 1100 may be a software algorithm that is stored in memory and executed by one or more processors (and/or processing circuitry) of a computer system hosting the one or more network nodes. In some embodiments, process 1100 may be executed to properly release and/or remove an F1 connection between an IAB-DU and a F1 terminating IAB donor (e.g., an IAB-DU donor) according to a second solution of the disclosed subject matter.

In block 1101, process 1100 includes receiving, by a F1 terminating donor from a non-F1 terminating donor, an IAB transport migration modification request indicating that the IAB node and/or its associated IAB-MT has been de-authorized to operate in a network.

In block 1102, process 1100 includes sending, to the non-F1 terminating donor, an IAB transport migration modification response acknowledging the receipt of the IAB transport migration modification request.

In block 1103, process 1100 includes sending, by the F1 terminating donor to an IAB-DU associated with the IAB node, a request for releasing an F1 connection established between the IAB-DU and the F1 terminating donor.

In some embodiments, the F1 terminating donor is a donor serving the IAB-DU. In some embodiments, wherein the non-F1 terminating donor is a donor serving the IAB-MT or an RRC terminating donor. In some embodiments, the non-F1 terminating donor initiates a removal of backhaul resources associated with the IAB node in response to receiving the IAB transport migration management request. In some embodiments, the non-F1 terminating donor initiates a removal of a BAP routing configuration at the IAB node and/or at one or more ancestor nodes of the IAB node in response to receiving the IAB transport migration modification response. In some embodiments, the F1 terminating donor transfers one or more UEs served by one or more cells configured on the IAB node to one or more cells served by one or more other IAB nodes and/or RAN nodes. In some embodiments, the F1 terminating donor is separate and distinct from the non-F1 terminating donor. In some embodiments, the IAB node comprises a mobile IAB node and wherein the non-F1 terminating donor is a RRC terminating IAB-donor. In some embodiments, wherein the IAB-MT comprises a mobile IAB-MT and the IAB-DU comprises a mobile IAB-DU. In some embodiments, the IAB transport migration modification response message is sent to the non-F1 terminating donor prior to the release and/or removal of the F1 connection.

In some embodiments, the F1 terminating donor is configured to send, to the non-F1 terminating donor, an IAB transport migration management request that indicates that the F1 connection with the IAB-DU has been removed and to request a release of the backhaul resources used for serving the IAB node and/or its IAB-MT. In some embodiments, the non-F1 terminating donor sends, to the F1 terminating donor, an IAB transport migration management response that confirms receipt of the IAB transport migration management request. In some embodiments, the non-F1 terminating donor may reconfigure an RRC connection towards the IAB-MT by removing backhaul related configurations. In some embodiments, the wherein the IAB node comprises a dual-connected IAB node. In some embodiments, the IAB-MT of the dual-connected IAB node is configured to support one or more of new radio, NR, dual connectivity (DC) and/or Evolved UMTS Terrestrial Radio Access, E-UTRA, NR DC.

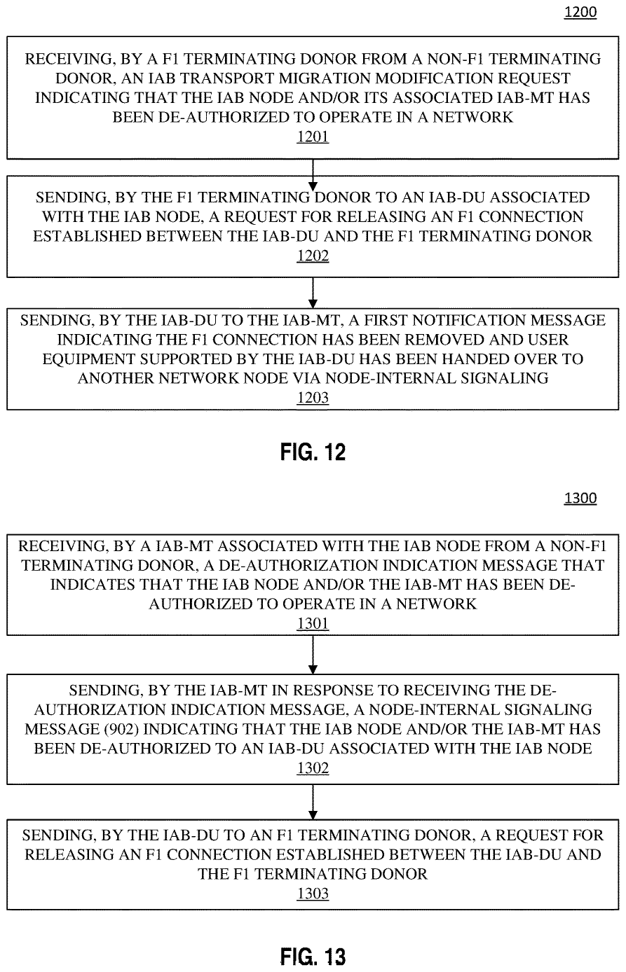

FIG. 12 is a flow chart of a method and/or process 1200 executed by one or more network nodes (e.g., a IAB-DU donor node, IAB-MT donor node, IAB node, F1 terminating node, non-F1 terminating node, IAB-DU, IAB-MT, and/or the like). In some embodiments, process 1200 may be a software algorithm that is stored in memory and executed by one or more processors (and/or processing circuitry) of a computer system hosting the one or more network nodes. In some embodiments, process 1200 may be executed to properly release and/or remove an F1 connection between an IAB-DU and a F1 terminating IAB donor (e.g., an IAB-DU donor) according to a third solution of the disclosed subject matter.

In block 1201, process 1200 includes receiving, by a F1 terminating donor from a non-F1 terminating donor, an IAB transport migration modification request indicating that the IAB node and/or its associated IAB-MT has been de-authorized to operate in a network.

In block 1202, process 1200 includes sending, by the F1 terminating donor to an IAB-DU associated with the IAB node, a request for releasing an F1 connection established between the IAB-DU and the F1 terminating donor.

In block 1203, process 1200 includes sending, by the IAB-DU to the IAB-MT, a first notification message indicating the F1 connection has been removed and user equipment supported by the IAB-DU have been handed over to another network node via node-internal signaling.

In some embodiments, the IAB-MT sends a second notification message to the non-F1 terminating donor indicating that the F1 connection has been removed between the IAB-DU and the F1 terminating donor. In some embodiments, the F1 terminating donor is a donor serving the IAB-DU. In some embodiments, the non-F1 terminating donor is a donor serving the IAB-MT. In some embodiments, the non-F1 terminating donor initiates a removal of backhaul resources associated with the IAB node in response to receiving the second notification message from the IAB-MT. In some embodiments, the non-F1 terminating donor initiates a removal of a BAP routing configuration at the IAB node and/or at one or more ancestor nodes of the IAB node in response to receiving the second notification message from the IAB-MT.

In some embodiments, the F1 terminating donor transfers one or more UEs served by one or more cells configured on the IAB node to one or more cells served by one or more other IAB nodes and/or RAN nodes. In some embodiments, the F1 terminating donor is separate and distinct from the non-F1 terminating donor. In some embodiments, the IAB node comprises a mobile IAB node and wherein the non-F1 terminating donor is a Radio Resource Control, RRC, terminating IAB-donor. In some embodiments, the IAB-MT comprises a mobile IAB-MT and the IAB-DU comprises a mobile IAB-DU. In some embodiments, a IAB transport migration modification response message is sent to the non-F1 terminating donor prior to the release and/or removal of the F1 connection. In some embodiments, the IAB-MT donor may reconfigure an RRC connection towards the IAB-MT by removing backhaul related configurations. In some embodiments, the wherein the IAB node comprises a dual-connected IAB node. In some embodiments, the IAB-MT of the dual-connected IAB node is configured to support one or more of new radio, NR, dual connectivity (DC) and/or Evolved UMTS Terrestrial Radio Access, E-UTRA, NR DC.

FIG. 13 is a flow chart of a method and/or process 1300 executed by one or more network nodes (e.g., a IAB-DU donor node, IAB-MT donor node, IAB node, F1 terminating node, non-F1 terminating node, IAB-DU, IAB-MT, and/or the like). In some embodiments, process 1300 may be a software algorithm that is stored in memory and executed by one or more processors (and/or processing circuitry) of a computer system hosting the one or more network nodes. In some embodiments, process 1300 may be executed to properly release and/or remove an F1 connection between an IAB-DU and a F1 terminating IAB donor (e.g., an IAB-DU donor) according to a fourth solution of the disclosed subject matter.

In block 1301, process 1300 includes receiving, by a IAB-MT (970) associated with the IAB node (930) from a non-F1 terminating donor, a de-authorization indication message (901) that indicates that the IAB node (930) and/or the IAB-MT (970) has been de-authorized to operate in a network.

In block 1302, process 1300 includes sending, by the IAB-MT (970) in response to receiving the de-authorization indication message (901), a node-internal signaling message (902) indicating that the IAB node (930) and/or the IAB-MT (970) has been de-authorized to an IAB-DU (960) associated with the IAB node (930).

In block 1303, process 1300 includes sending, by the IAB-DU (960) to an F1 terminating donor (950), a request for releasing an F1 connection established between the IAB-DU (960) and the F1 terminating donor.

In some embodiments, the IAB-MT is configured to send a notification message to the non-F1 terminating donor indicating the F1 connection has been removed. In some embodiments, the F1 terminating donor is configured to send a notification message to the non-F1 terminating donor indicating the F1 connection has been removed. In some embodiments, the F1 terminating donor is a donor serving the IAB-DU. In some embodiments, the non-F1 terminating donor is a donor serving the IAB-MT. In some embodiments, the non-F1 terminating donor initiates a removal of backhaul resources associated with the IAB node in response to receiving the second notification message from the IAB-MT.

In some embodiments, the non-F1 terminating donor initiates a removal of a BAP routing configuration at the IAB node and/or at one or more ancestor nodes of the IAB node in response to receiving the second notification message from the IAB-MT. In some embodiments, the IAB node comprises a mobile IAB node and wherein the non-F1 terminating donor is a Radio Resource Control, RRC, terminating IAB-donor. In some embodiments, the IAB-MT comprises a mobile IAB-MT and the IAB-DU comprises a mobile IAB-DU. In some embodiments, the IAB node comprises a dual-connected IAB node. In some embodiments, the IAB-MT of the dual-connected IAB node is configured to support one or more of new radio, NR, dual connectivity (DC) and/or Evolved UMTS Terrestrial Radio Access, E-UTRA, NR DC.

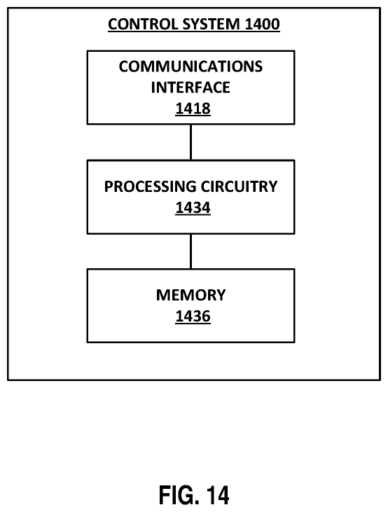

FIG. 14 is a block diagram of a control system 1400 according to some embodiments. The control system 1400 includes processing circuitry 1434, a communication interface 1418 coupled to the processing circuitry 1434, and a memory 1436 coupled to the processing circuitry 1434. The processing circuitry 1434 may be a single processor or may comprise a multi-processor system. In some embodiments, processing may be performed by multiple different systems that share processing power, such as in a distributed or cloud computing system. The memory 1436 includes machine-readable computer program instructions that, when executed by the processing circuitry, cause the processor circuit to perform some of the operations and/or implement the functions depicted described herein (e.g., process 1000 described above). In some embodiments, the control system 1400 may include a network node that includes and/or hosts a IAB-MT donor, IAB-DU donor, IAB node, IAB-DU, IAB-MT, F1 terminating donor, a non-F1 terminating donor, and/or the like.

As shown, the control system 1400 includes a communication interface 1418 (also referred to as a network interface) configured to provide communications with other devices. The network management system 100 also includes a processing circuitry 1434 (also referred to as a processor) and a memory circuit 136 (also referred to as memory) coupled to the processing circuitry 1434. According to other embodiments, processor circuit 134 may be defined to include memory so that a separate memory circuit is not required.

As discussed herein, operations of the control system 1400 may be performed by processing circuitry 1434 and/or communication interface 1418. For example, the processing circuitry 1434 may control the communication interface 1418 to transmit communications through the communication interface 1418 to one or more other devices and/or to receive communications through network interface from one or more other devices. Moreover, modules may be stored in memory 1436, and these modules may provide instructions so that when instructions of a module are executed by processing circuitry 1434, processing circuitry 1434 performs respective operations discussed herein (e.g., operations associated with process 1000 described above) with respect to example embodiments.

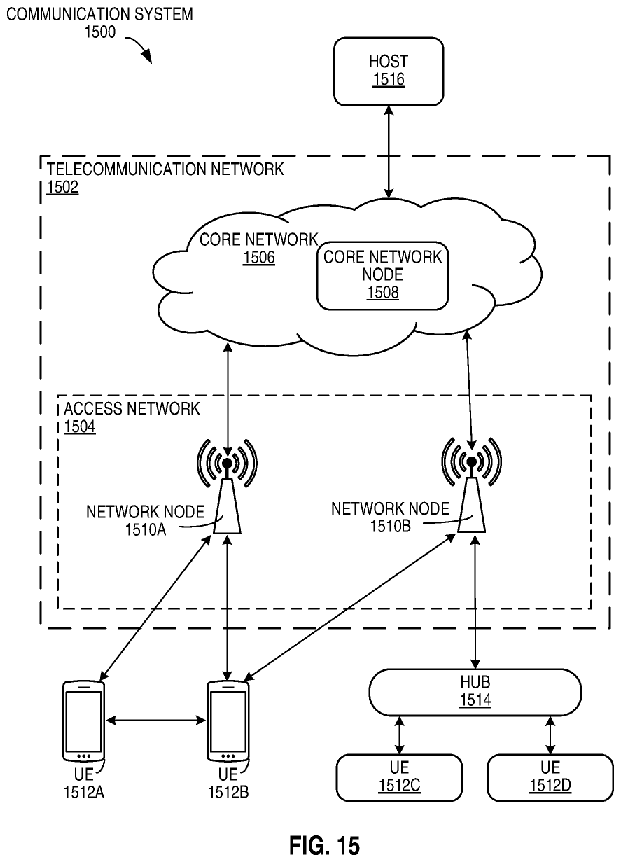

FIG. 15 shows an example of a communication system 1500 in accordance with some embodiments.

In the example, the communication system 1500 includes a telecommunication network 1502 that includes an access network 1504, such as a radio access network (RAN), and a core network 1506, which includes one or more core network nodes 1508. The access network 1504 includes one or more access network nodes, such as network nodes 1510a and 1510b (one or more of which may be generally referred to as network nodes 1510), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1502 includes one or more Open-RAN (ORAN) network nodes. An ORAN network node is a node in the telecommunication network 1502 that supports an ORAN specification (e.g., a specification published by the O-RAN Alliance, or any similar organization) and may operate alone or together with other nodes to implement one or more functionalities of any node in the telecommunication network 1502, including one or more network nodes 1510 and/or core network nodes 1508.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1510 facilitate direct or indirect connection of user equipment (UE), such as by connecting UEs 1512a, 1512b, 1512c, and 1512d (one or more of which may be generally referred to as UEs 1512) to the core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1500 may include any number of wired or wireless networks, network nodes, UEs, and/or any other components or systems that may facilitate or participate in the communication of data and/or signals whether via wired or wireless connections. The communication system 1500 may include and/or interface with any type of communication, telecommunication, data, cellular, radio network, and/or other similar type of system.

The UEs 1512 may be any of a wide variety of communication devices, including wireless devices arranged, configured, and/or operable to communicate wirelessly with the network nodes 1510 and other communication devices. Similarly, the network nodes 1510 are arranged, capable, configured, and/or operable to communicate directly or indirectly with the UEs 1512 and/or with other network nodes or equipment in the telecommunication network 1502 to enable and/or provide network access, such as wireless network access, and/or to perform other functions, such as administration in the telecommunication network 1502.

In the depicted example, the core network 1506 connects the network nodes 1510 to one or more hosts, such as host 1516. These connections may be direct or indirect via one or more intermediary networks or devices. In other examples, network nodes may be directly coupled to hosts. The core network 1506 includes one more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1516 may be under the ownership or control of a service provider other than an operator or provider of the access network 1504 and/or the telecommunication network 1502, and may be operated by the service provider or on behalf of the service provider. The host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1502 is a cellular network that implements 3GPP standardized features. Accordingly, the telecommunications network 1502 may support network slicing to provide different logical networks to different devices that are connected to the telecommunication network 1502. For example, the telecommunications network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IT services to yet further UEs.

In some examples, the UEs 1512 are configured to transmit and/or receive information without direct human interaction. For instance, a UE may be designed to transmit information to the access network 1504 on a predetermined schedule, when triggered by an internal or external event, or in response to requests from the access network 1504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC). As described herein, dual connectivity by means of EN-DC includes scenarios where one leg of a dual-connected MT is served by an eNB (which provides LTE radio access) and another leg is served by a donor (e.g., which may be a gNB that provides NR radio access).

In the example, the hub 1514 communicates with the access network 1504 to facilitate indirect communication between one or more UEs (e.g., UE 1512c and/or 1512d) and network nodes (e.g., network node 1510b). In some examples, the hub 1514 may be a controller, router, content source and analytics, or any of the other communication devices described herein regarding UEs. For example, the hub 1514 may be a broadband router enabling access to the core network 1506 for the UEs. As another example, the hub 1514 may be a controller that sends commands or instructions to one or more actuators in the UEs. Commands or instructions may be received from the UEs, network nodes 1510, or by executable code, script, process, or other instructions in the hub 1514. As another example, the hub 1514 may be a data collector that acts as temporary storage for UE data and, in some embodiments, may perform analysis or other processing of the data. As another example, the hub 1514 may be a content source. For example, for a UE that is a VR headset, display, loudspeaker or other media delivery device, the hub 1514 may retrieve VR assets, video, audio, or other media or data related to sensory information via a network node, which the hub 1514 then provides to the UE either directly, after performing local processing, and/or after adding additional local content. In still another example, the hub 1514 acts as a proxy server or orchestrator for the UEs, in particular if one or more of the UEs are low energy IoT devices.

The hub 1514 may have a constant/persistent or intermittent connection to the network node 1510b. The hub 1514 may also allow for a different communication scheme and/or schedule between the hub 1514 and UEs (e.g., UE 1512c and/or 1512d), and between the hub 1514 and the core network 1506. In other examples, the hub 1514 is connected to the core network 1506 and/or one or more UEs via a wired connection. Moreover, the hub 1514 may be configured to connect to an M2M service provider over the access network 1504 and/or to another UE over a direct connection. In some scenarios, UEs may establish a wireless connection with the network nodes 1510 while still connected via the hub 1514 via a wired or wireless connection. In some embodiments, the hub 1514 may be a dedicated hub—that is, a hub whose primary function is to route communications to/from the UEs from/to the network node 1510b. In other embodiments, the hub 1514 may be a non-dedicated hub—that is, a device which is capable of operating to route communications between the UEs and network node 1510b, but which is additionally capable of operating as a communication start and/or end point for certain data channels.

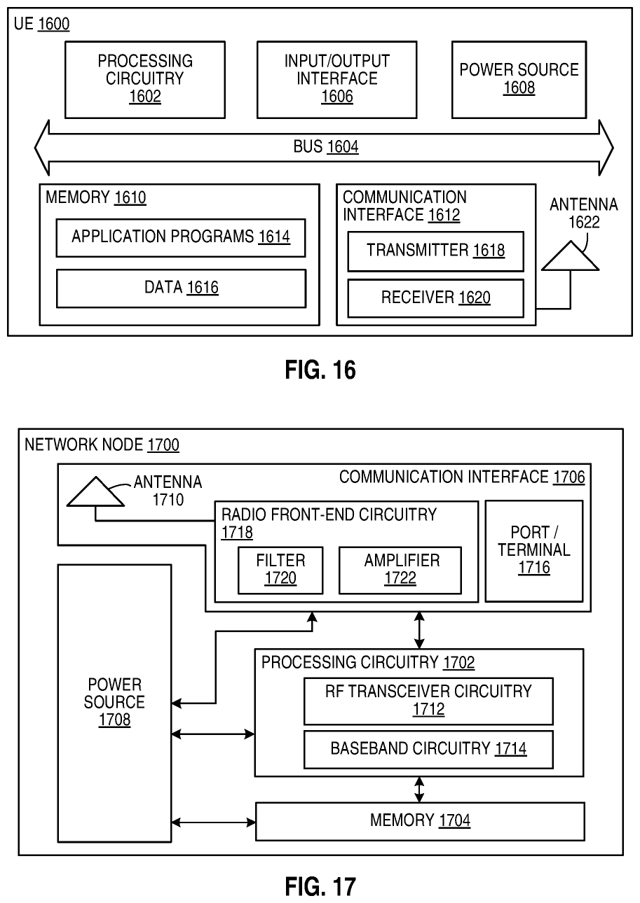

FIG. 16 shows a UE 1600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1600 includes processing circuitry 1602 that is operatively coupled via a bus 1604 to an input/output interface 1606, a power source 1608, a memory 1610, a communication interface 1612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1602 is configured to process instructions and data and may be configured to implement any sequential state machine operative to execute instructions stored as machine-readable computer programs in the memory 1610. The processing circuitry 1602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1602 may include multiple central processing units (CPUs).

In the example, the input/output interface 1606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1608 is structured as a battery or battery pack. Other types of power sources, such as an external power source (e.g., an electricity outlet), photovoltaic device, or power cell, may be used. The power source 1608 may further include power circuitry for delivering power from the power source 1608 itself, and/or an external power source, to the various parts of the UE 1600 via input circuitry or an interface such as an electrical power cable. Delivering power may be, for example, for charging of the power source 1608. Power circuitry may perform any formatting, converting, or other modification to the power from the power source 1608 to make the power suitable for the respective components of the UE 1600 to which power is supplied.

The memory 1610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1610 includes one or more application programs 1614, such as an operating system, web browser application, a widget, gadget engine, or other application, and corresponding data 1616. The memory 1610 may store, for use by the UE 1600, any of a variety of various operating systems or combinations of operating systems.

The memory 1610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1610 may allow the UE 1600 to access instructions, application programs and the like, stored on transitory or non-transitory memory media, to off-load data, or to upload data. An article of manufacture, such as one utilizing a communication system may be tangibly embodied as or in the memory 1610, which may be or comprise a device-readable storage medium.

The processing circuitry 1602 may be configured to communicate with an access network or other network using the communication interface 1612. The communication interface 1612 may comprise one or more communication subsystems and may include or be communicatively coupled to an antenna 1622. The communication interface 1612 may include one or more transceivers used to communicate, such as by communicating with one or more remote transceivers of another device capable of wireless communication (e.g., another UE or a network node in an access network). Each transceiver may include a transmitter 1618 and/or a receiver 1620 appropriate to provide network communications (e.g., optical, electrical, frequency allocations, and so forth). Moreover, the transmitter 1618 and receiver 1620 may be coupled to one or more antennas (e.g., antenna 1622) and may share circuit components, software or firmware, or alternatively be implemented separately.

In the illustrated embodiment, communication functions of the communication interface 1612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1700 includes a processing circuitry 1702, a memory 1704, a communication interface 1706, and a power source 1708. The network node 1700 may be composed of multiple physically separate components (e.g., a NodeB component and a RNC component, or a BTS component and a BSC component, etc.), which may each have their own respective components. In certain scenarios in which the network node 1700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1700 may be configured to support multiple radio access technologies (RATs). In such embodiments, some components may be duplicated (e.g., separate memory 1704 for different RATs) and some components may be reused (e.g., a same antenna 1710 may be shared by different RATs). The network node 1700 may also include multiple sets of the various illustrated components for different wireless technologies integrated into network node 1700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1700.

The processing circuitry 1702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1700 components, such as the memory 1704, to provide network node 1700 functionality.

In some embodiments, the processing circuitry 1702 includes a system on a chip (SOC). In some embodiments, the processing circuitry 1702 includes one or more of radio frequency (RF) transceiver circuitry 1712 and baseband processing circuitry 1714. In some embodiments, the radio frequency (RF) transceiver circuitry 1712 and the baseband processing circuitry 1714 may be on separate chips (or sets of chips), boards, or units, such as radio units and digital units. In alternative embodiments, part or all of RF transceiver circuitry 1712 and baseband processing circuitry 1714 may be on the same chip or set of chips, boards, or units.

The memory 1704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1702. The memory 1704 may store any suitable instructions, data, or information, including a computer program, software, an application including one or more of logic, rules, code, tables, and/or other instructions capable of being executed by the processing circuitry 1702 and utilized by the network node 1700. The memory 1704 may be used to store any calculations made by the processing circuitry 1702 and/or any data received via the communication interface 1706. In some embodiments, the processing circuitry 1702 and memory 1704 is integrated.

The communication interface 1706 is used in wired or wireless communication of signaling and/or data between a network node, access network, and/or UE. As illustrated, the communication interface 1706 comprises port(s)/terminal(s) 1716 to send and receive data, for example to and from a network over a wired connection. The communication interface 1706 also includes radio front-end circuitry 1718 that may be coupled to, or in certain embodiments a part of, the antenna 1710. Radio front-end circuitry 1718 comprises filters 1720 and amplifiers 1722. The radio front-end circuitry 1718 may be connected to an antenna 1710 and processing circuitry 1702. The radio front-end circuitry may be configured to condition signals communicated between antenna 1710 and processing circuitry 1702. The radio front-end circuitry 1718 may receive digital data that is to be sent out to other network nodes or UEs via a wireless connection. The radio front-end circuitry 1718 may convert the digital data into a radio signal having the appropriate channel and bandwidth parameters using a combination of filters 1720 and/or amplifiers 1722. The radio signal may then be transmitted via the antenna 1710. Similarly, when receiving data, the antenna 1710 may collect radio signals which are then converted into digital data by the radio front-end circuitry 1718. The digital data may be passed to the processing circuitry 1702. In other embodiments, the communication interface may comprise different components and/or different combinations of components.

In certain alternative embodiments, the network node 1700 does not include separate radio front-end circuitry 1718, instead, the processing circuitry 1702 includes radio front-end circuitry and is connected to the antenna 1710. Similarly, in some embodiments, all or some of the RF transceiver circuitry 1712 is part of the communication interface 1706. In still other embodiments, the communication interface 1706 includes one or more ports or terminals 1716, the radio front-end circuitry 1718, and the RF transceiver circuitry 1712, as part of a radio unit (not shown), and the communication interface 1706 communicates with the baseband processing circuitry 1714, which is part of a digital unit (not shown).

The antenna 1710 may include one or more antennas, or antenna arrays, configured to send and/or receive wireless signals. The antenna 1710 may be coupled to the radio front-end circuitry 1718 and may be any type of antenna capable of transmitting and receiving data and/or signals wirelessly. In certain embodiments, the antenna 1710 is separate from the network node 1700 and connectable to the network node 1700 through an interface or port.

The antenna 1710, communication interface 1706, and/or the processing circuitry 1702 may be configured to perform any receiving operations and/or certain obtaining operations described herein as being performed by the network node. Any information, data and/or signals may be received from a UE, another network node and/or any other network equipment. Similarly, the antenna 1710, the communication interface 1706, and/or the processing circuitry 1702 may be configured to perform any transmitting operations described herein as being performed by the network node. Any information, data and/or signals may be transmitted to a UE, another network node and/or any other network equipment.

The power source 1708 provides power to the various components of network node 1700 in a form suitable for the respective components (e.g., at a voltage and current level needed for each respective component). The power source 1708 may further comprise, or be coupled to, power management circuitry to supply the components of the network node 1700 with power for performing the functionality described herein. For example, the network node 1700 may be connectable to an external power source (e.g., the power grid, an electricity outlet) via an input circuitry or interface such as an electrical cable, whereby the external power source supplies power to power circuitry of the power source 1708. As a further example, the power source 1708 may comprise a source of power in the form of a battery or battery pack which is connected to, or integrated in, power circuitry. The battery may provide backup power should the external power source fail.

Embodiments of the network node 1700 may include additional components beyond those shown in FIG. 17 for providing certain aspects of the network node's functionality, including any of the functionality described herein and/or any functionality necessary to support the subject matter described herein. For example, the network node 1700 may include user interface equipment to allow input of information into the network node 1700 and to allow output of information from the network node 1700. This may allow a user to perform diagnostic, maintenance, repair, and other administrative functions for the network node 1700.

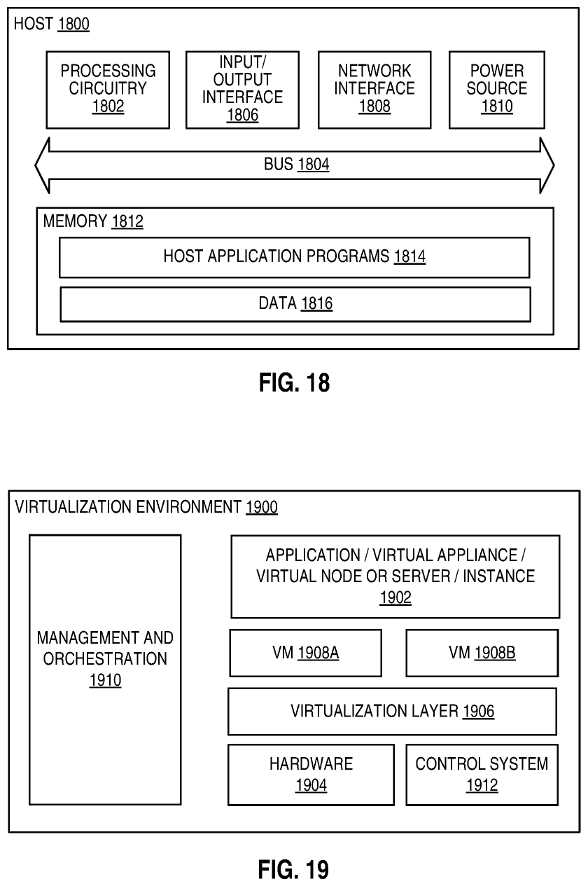

FIG. 18 is a block diagram of a host 1800, which may be an embodiment of the host 1516 of FIG. 15, in accordance with various aspects described herein. As used herein, the host 1800 may be or comprise various combinations hardware and/or software, including a standalone server, a blade server, a cloud-implemented server, a distributed server, a virtual machine, container, or processing resources in a server farm. The host 1800 may provide one or more services to one or more UEs.

The host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 16 and 17, such that the descriptions thereof are generally applicable to the corresponding components of host 1800.

The memory 1812 may include one or more computer programs including one or more host application programs 1814 and data 1816, which may include user data, e.g., data generated by a UE for the host 1800 or data generated by the host 1800 for a UE. Embodiments of the host 1800 may utilize only a subset or all of the components shown. The host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1814 may also provide for user authentication and licensing checks and may periodically report health, routes, and content availability to a central node, such as a device in or on the edge of a core network. Accordingly, the host 1800 may select and/or indicate a different host for over-the-top services for a UE. The host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1900 includes components defined by the O-RAN Alliance, such as an O-Cloud environment orchestrated by a Service Management and Orchestration Framework via an O-2 interface.

Applications 1902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908a and 1908b (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

The VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1908 may be a software implementation of a physical machine that runs programs as if they were executing on a physical, non-virtualized machine. Each of the VMs 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g. such as in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

1. A method performed by a network node for conducting de-authorization of an IAB node, the method comprising:
   receiving (1001), by a F1 terminating donor (650) from a non-F1 terminating donor (640), an IAB transport migration modification request (601) indicating that the IAB node (630) and/or its associated IAB-MT (670) has been de-authorized to operate in a network;
   sending (1002), by the F1 terminating donor (650) to an IAB-DU (660) associated with the IAB node (630), a request (603) for releasing an F1 connection established between the IAB-DU (660) and the F1 terminating donor (650); and
   sending (1003), to the non-F1 terminating donor (640), an IAB transport migration modification response (606) indicating that the F1 connection has been removed or will be removed.
2. The method of embodiment 1, wherein the F1 terminating donor is a IAB-DU donor.
3. The method of any one of embodiments 1 to 2, wherein the non-F1 terminating donor is a IAB-MT donor.
4. The method of any one of embodiments 1 to 3, wherein the non-F1 terminating donor initiates a removal of backhaul resources associated with the IAB node in response to receiving the IAB transport migration modification response.
5. The method of any one of embodiments 1 to 4, wherein the non-F1 terminating donor initiates a removal of a Backhaul Adaptation Protocol, BAP, routing configuration at one or more ancestor nodes of the IAB node in response to receiving the IAB transport migration modification response.
6. The method of any one of embodiments 1 to 5, wherein the F1 terminating donor transfers one or more UEs served by one or more cells configured on the IAB node to one or more cells served by one or more other IAB nodes and/or RAN nodes.
7. The method of any one of embodiments 1 to 6, wherein the F1 terminating donor is separate and distinct from the non-F1 terminating donor.
8. The method of any one of embodiments 1 to 7, wherein the IAB node comprises a mobile IAB node.
9. The method of any one of embodiments 1 to 8, wherein the IAB-MT comprises a mobile IAB-MT and the IAB-DU comprises a mobile IAB-DU.
10. The method of any one of embodiments 1 to 9, wherein the IAB transport migration modification response message is sent to the IAB-MT donor prior to the release and/or removal of the F1 connection.
11. The method of any one of embodiments 1 to 10, wherein the IAB-DU donor is configured to send, to the IAB-MT donor, an IAB transport migration management request that indicates that the F1 connection with the IAB-DU has been removed and to request a release of the backhaul resources used for serving the IAB node and/or its IAB-MT.
12. The method of any one of embodiments 1 to 11, wherein the IAB-MT donor sends, to the IAB-DU donor, an IAB transport migration management response that confirms receipt of the IAB transport migration management request.
13. The method of any one of embodiments 1 to 12, wherein the IAB-MT donor may reconfigure an RRC connection towards the IAB-MT by removing backhaul related configurations.
14. A method performed by a network node for conducting de-authorization of an IAB node, the method comprising:
   receiving, by a F1 terminating donor (850) from a non-F1 terminating donor (840), an IAB transport migration modification request (801) indicating that the IAB node (830) and/or its associated IAB-MT (870) has been de-authorized to operate in a network;
   sending, by the F1 terminating donor (850) to an IAB-DU (860) associated with the IAB node (830), a request (804) for releasing an F1 connection established between the IAB-DU (860) and the F1 terminating donor (850); and
   sending, by the IAB-DU (860) to the IAB-MT (870), a first notification message (807) indicating the F1 connection has been removed via node-internal signaling.
15. The method of embodiment 14, wherein the IAB-MT sends a second notification message to the non-F1 terminating donor indicating that the F1 connection has been removed between the IAB-DU and the F1 terminating donor.
16. The method of any one of embodiments 14 to 15, wherein the F1 terminating donor is a IAB-DU donor.
17. The method of any one of embodiments 14 to 16, wherein the non-F1 terminating donor is a IAB-MT donor.
18. The method of any one of embodiments 14 to 17, wherein the non-F1 terminating donor initiates a removal of backhaul resources associated with the IAB node in response to receiving the second notification message from the IAB-MT.
19. The method of any one of embodiments 14 to 18, wherein the non-F1 terminating donor initiates a removal of a Backhaul Adaptation Protocol, BAP, routing configuration at one or more ancestor nodes of the IAB node in response to receiving the second notification message from the IAB-MT.
20. The method of any one of embodiments 14 to 19, wherein the F1 terminating donor transfers one or more UEs served by one or more cells configured on the IAB node to one or more cells served by one or more other IAB nodes and/or radio access network, RAN, nodes.
21. The method of any one of embodiments 14 to 20, wherein the F1 terminating donor is separate and distinct from the non-F1 terminating donor.
22. The method of any one of embodiments 14 to 21, wherein the IAB node comprises a mobile IAB node.
23. The method of any one of embodiments 14 to 22, wherein the IAB-MT comprises a mobile IAB-MT and the IAB-DU comprises a mobile IAB-DU.
24. The method of any one of embodiments 14 to 23, wherein a IAB transport migration modification response message is sent to the IAB-MT donor prior to the release and/or removal of the F1 connection.
25. The method of any one of embodiments 14 to 24, wherein the IAB-MT donor may reconfigure an RRC connection towards the IAB-MT by removing backhaul related configurations.
26. A method performed by a network node for conducting de-authorization of an IAB node, the method comprising:
   receiving, by a IAB-MT (970) associated with the IAB node (930) from a non-F1 terminating donor, a de-authorization indication message (901) that indicates that the IAB node (930) and/or the IAB-MT (970) has been de-authorized to operate in a network;
   sending, by the IAB-MT (970) in response to receiving the de-authorization indication message (901), a node-internal signaling message (902) indicating that the IAB node (930) and/or the IAB-MT (970) has been de-authorized to an IAB-DU (960) associated with the IAB node (930); and
   sending, by the IAB-DU (960) to an F1 terminating donor (950), a request for releasing an F1 connection established between the IAB-DU (960) and the F1 terminating donor (950).
27. The method of embodiment 26 wherein, the IAB-MT is configured to send a notification message to the non-F1 terminating donor indicating the F1 connection has been removed.
28. The method of embodiment 26 wherein, the F1 terminating donor is configured to send a notification message to the non-F1 terminating donor indicating the F1 connection has been removed.
29. The method of any one of embodiments 26 to 28, wherein the F1 terminating donor is a IAB-DU donor.
30. The method of any one of embodiments 26 to 29, wherein the non-F1 terminating donor is a IAB-MT donor.
31. The method of any one of embodiments 26 to 30, wherein the non-F1 terminating donor initiates a removal of backhaul resources associated with the IAB node in response to receiving the second notification message from the IAB-MT.
32. The method of any one of embodiments 26 to 31, wherein the non-F1 terminating donor initiates a removal of a Backhaul Adaptation Protocol, BAP, routing configuration at one or more ancestor nodes of the IAB node in response to receiving the second notification message from the IAB-MT.
33. The method of any of the previous embodiments, further comprising:
   obtaining user data; and
   forwarding the user data to a host or a user equipment.
34. A network node for conducting de-authorization of an IAB node, the network node comprising:
   processing circuitry configured to perform any of the steps of any one of embodiments 1 to 32; and
   power supply circuitry configured to supply power to the processing circuitry.
35. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any one of embodiments 1 to 32 to transmit the user data from the host to the UE.
36. The method of the previous embodiment, further comprising, at the network node, transmitting the user data provided by the host for the UE.
37. The method of any of the previous 2 embodiments, wherein the user data is provided at the host by executing a host application that interacts with a client application executing on the UE, the client application being associated with the host application.
38. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
39. The method of the previous embodiment, further comprising at the network node, transmitting the received user data to the host.
40. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any one of embodiments 1 to 32 to receive the user data from the host.
42. The method of the previous embodiment, further comprising:
   at the host, executing a host application associated with a client application executing on the UE to receive the user data from the host application.
43. The method of the previous embodiment, further comprising:
   at the host, transmitting input data to the client application executing on the UE, the input data being provided by executing the host application,
   wherein the user data is provided by the client application in response to the input data from the host application.
44. A method implemented by a host configured to operate in a communication system that further includes a network node and a user equipment (UE), the method comprising:
   at the host, receiving user data transmitted to the host via the network node by the UE, wherein the UE performs any of the steps of any one of embodiments 1 to 32 to transmit the user data to the host.
45. The method of the previous embodiment, further comprising:
   at the host, executing a host application associated with a client application executing on the UE to receive the user data from the UE.
46. The method of the previous 2 embodiments, further comprising:
   at the host, transmitting input data to the client application executing on the UE, the input data being provided by executing the host application,
   wherein the user data is provided by the client application in response to the input data from the host application.

1. A method performed by a network node for conducting de-authorization of an integrated access and backhaul, IAB, node, the method comprising:
receiving, by a F1 terminating donor from a non-F1 terminating donor, an IAB transport migration modification request indicating that the IAB node and/or its associated IAB-MT has been de-authorized to operate in a network;
sending, by the F1 terminating donor to an IAB-DU associated with the IAB node, a request for releasing an F1 connection established between the IAB-DU and the F1 terminating donor; and
sending, to the non-F1 terminating donor, an IAB transport migration modification response requesting a release of resources used by the non-F1 terminating donor to facilitate the packet traffic communicated to and from the IAB node.

2. The method of claim 1, wherein the F1 terminating donor is a donor serving the IAB-DU.

3. The method of claim 1, wherein the non-F1 terminating donor is a donor serving the IAB-MT.

4. The method of claim 1, wherein the non-F1 terminating donor initiates at least one of:
a removal of backhaul resources associated with the IAB node in response to receiving the IAB transport migration modification response; and
a removal of a BAP routing configuration at the IAB node and/or at one or more ancestor nodes of the LAB node in response to receiving the IAB transport migration modification response.

5. (canceled)

6. The method of claim 1, wherein the F1 terminating donor transfers one or more UEs served by one or more cells configured on the IAB node to one or more cells served by one or more other IAB nodes and/or radio access network, RAN, nodes.

7. The method of claim 1, wherein the F1 terminating donor is separate and distinct from the non-F1 terminating donor.

8. The method of claim 1, wherein the IAB node comprises a mobile IAB node and wherein the non-F1 terminating donor is a Radio Resource Control, RRC, terminating IAB-donor.

9. The method of claim 1, wherein the IAB-MT comprises a mobile IAB-MT and the IAB-DU comprises a mobile IAB-DU.

10. The method of claim 1, wherein the IAB transport migration modification response message is sent to the non-F1 terminating donor after the release and/or removal of the F1 connection and a handover of UEs from the IAB-DU to another network node.

11. The method of claim 1, wherein the donor serving the IAB-MT may reconfigure an RRC connection towards the IAB-MT by removing backhaul related configurations.

12. The method of claim 1 wherein the IAB node comprises a dual-connected IAB node, and
wherein the IAB-MT of the dual-connected IAB node is configured to support one or more of new radio, NR, dual connectivity (DC) and/or Evolved UMTS Terrestrial Radio Access, E-UTRA, NR DC.

13. (canceled)

14. A method performed by a network node for conducting de-authorization of an integrated access and backhaul, IAB, node, the method comprising:
receive, by a F1 terminating donor from a non-F1 terminating donor, an IAB transport migration modification request indicating that the IAB node and/or its associated IAB-MT has been de-authorized to operate in a network;
send, by the F1 terminating donor to an IAB-DU associated with the IAB node, a request for releasing an F1 connection established between the IAB-DU and the F1 terminating donor; and
send, by the IAB-DU to the IAB-MT, a first notification message indicating the F1 connection has been removed and user equipment supported by the IAB-DU have been handed over to another network node via node-internal signaling.

15. The method of claim 14, wherein the IAB-MT sends a second notification message to the non-F1 terminating donor indicating that the F1 connection has been removed between the IAB-DU and the F1 terminating donor.

16. The method of claim 14, wherein at least one of:
the F1 terminating donor is a donor serving the IAB-DU;
the non-F1 terminating donor is a donor serving the IAB-MT;
the F1 terminating donor is separate and distinct from the non-F1 terminating donor;
the IAB node comprises a mobile IAB node and the non-F1 terminating donor is a Radio Resource Control, RRC, terminating IAB-donor; and
the IAB-MT comprises a mobile IAB-MT and the IAB-DU comprises a mobile IAB-DU.

17. (canceled)

18. The method of claim 14, wherein the non-F1 terminating donor initiates at least one of:
a removal of backhaul resources associated with the IAB node in response to receiving the second notification message from the IAB-MT; and
a removal of a BAP routing configuration at the IAB node and/or at one or more ancestor nodes of the IAB node in response to receiving the second notification message from the IAB-MT.

19. (canceled)

20. The method of claim 14, wherein the F1 terminating donor transfers one or more UEs served by one or more cells configured on the IAB node to one or more cells served by one or more other IAB nodes and/or radio access network, RAN, nodes.

21-23. (canceled)

24. The method of claim 14, wherein at least one of:
a IAB transport migration modification response message is sent to the non-F1 terminating donor prior to the release and/or removal of the F1 connection; and
the IAB-MT donor may reconfigure an RRC connection towards the IAB-MT by removing backhaul related configurations.

25. (canceled)

26. The method of claim 14, wherein the IAB node comprises a dual-connected IAB node, and
wherein the IAB-MT of the dual-connected IAB node is configured to support one or more of new radio, NR, dual connectivity (DC) and/or Evolved UMTS Terrestrial Radio Access, E-UTRA, NR DC.

27. (canceled)

28. A method performed by a network node for conducting de-authorization of an integrated access and backhaul, IAB, node, the method comprising:
receive, by a IAB-MT associated with the IAB node from a non-F1 terminating donor, a de-authorization indication message that indicates that the IAB node and/or the IAB-MT has been de-authorized to operate in a network;
send, by the IAB-MT in response to receiving the de-authorization indication message, a node-internal signaling message indicating that the IAB node and/or the IAB-MT has been de-authorized to an IAB-DU associated with the IAB node; and
send, by the IAB-DU to an F1 terminating donor, a request for releasing an F1 connection established between the IAB-DU and the F1 terminating donor.

29-38. (canceled)

39. A method performed by a network node for conducting de-authorization of an integrated access and backhaul, IAB, node, the method comprising:
receiving, by a F1 terminating donor from a non-F1 terminating donor, an IAB transport migration modification request indicating that the IAB node and/or its associated IAB-MT has been de-authorized to operate in a network;
sending, to the non-F1 terminating donor, an IAB transport migration modification response acknowledging the receipt of the IAB transport migration modification request; and
sending, by the F1 terminating donor to an IAB-DU associated with the IAB node, a request for releasing an F1 connection established between the IAB-DU and the F1 terminating donor.

40-61. (canceled)
